(19) United States
(12) Patent Application Publication
(10) Pub. No.: US 2024/0255739 A1
(43) Pub. Date: Aug. 1, 2024

(54) ZOOM LENS AND IMAGE PICKUP APPARATUS

(71) Applicant: CANON KABUSHIKI KAISHA, Tokyo (JP)

(72) Inventors: TAKEO MORI, Tochigi (JP); MAKOTO NAKAHARA, Tochigi (JP)

(21) Appl. No.: 18/424,581

(22) Filed: Jan. 26, 2024

(30) Foreign Application Priority Data
Feb. 1, 2023 (JP) 2023-013764

(51) Int. Cl. G02B 15/14; G02B 27/64; H04N 23/68

(52) U.S. Cl. CPC G02B 15/1425; G02B 27/646; H04N 23/687; H04N 23/683

(57) ABSTRACT

A zoom lens includes, in order from an object side to an image side, a front group including a plurality of lens units, an image stabilizing unit having negative refractive power, and a rear group including one or more lens units. Each distance between adjacent lens units changes during zooming. The front group has a focus unit and an aperture stop. Predetermined inequalities are satisfied.

### BACKGROUND

### Technical Field

One of the aspects of the embodiments relates generally to a zoom lens and an image pickup apparatus having the same, and more particularly to a zoom lens suitable for digital video cameras, digital still cameras, broadcasting cameras, film-based cameras, surveillance cameras, and the like.

### Description of Related Art

Some conventional zoom lenses include an image stabilizing unit configured to correct image blur in a captured image due to camera shake, etc. (see Japanese Laid-Open No. 2022-36249).

An image blur amount is different between a central portion and a peripheral portion in the captured image. In particular, as the zoom lens have a wider angle, changes in perspective become larger, so the image blur amount at the peripheral portion of the image becomes larger than that at the central portion of the image. In the zoom lens disclosed in Japanese Laid-Open No. 2022-36249, even if image blur at the central portion of the image is corrected, image blur at the peripheral portion of the image remains.

### SUMMARY

A zoom lens according to one aspect of the disclosure includes, in order from an object side to an image side, a front group including a plurality of lens units, an image stabilizing unit having negative refractive power, and a rear group including one or more lens units. Each distance between adjacent lens units changes during zooming. The front group has a focus unit and an aperture stop. The following inequalities are satisfied:

$$0.4 < DISw / DSPw < 0.8$$

$$43.2 ° < ω w < 90. °$$

where DISw is a distance on an optical axis from the aperture stop to a lens surface closest to an object in the image stabilizing unit at a wide-angle end, DSPw is a distance on the optical axis from the aperture stop to an image plane at the wide-angle end, and ωw [°] is a half angle of view of the zoom lens at the wide-angle end. An image pickup apparatus having the above zoom lens also constitutes another aspect of the disclosure.

A zoom lens according to another aspect of the disclosure includes, in order from an object side to an image side, a front group including a plurality of lens units and an aperture stop, an image stabilizing unit having negative refractive power, and a rear group including one or more lens units. Each distance between adjacent lens units changes during zooming. The following inequalities are satisfied:

$$0.4 < DISw / DSPw < 0.8$$

$$0. < ( R 1 + R 2 ) / ( R 1 - R 2 ) < 13.$$

$$0.1 < Φ IS / Φ R < 0.8$$

where DISw is a distance on an optical axis from the aperture stop to a lens surface closest to an object in the image stabilizing unit at a wide-angle end, DSPw is a distance on the optical axis from the aperture stop to an image plane at the wide-angle end, R1 is a radius of curvature of a lens surface closest to the object of the image stabilizing unit, R2 is a radius of curvature of a lens surface closest to the image plane of the image stabilizing unit, ΦIS is a maximum effective diameter among lenses included in the image stabilizing unit, and ΦR is a maximum effective diameter among lenses included in a lens unit disposed closest to the image plane of the zoom lens. An image pickup apparatus having the above zoom lens also constitutes another aspect of the disclosure.

Further features of the disclosure will become apparent from the following description of embodiments with reference to the attached drawings.

### BRIEF DESCRIPTION OF THE DRAWINGS

FIG. 1 is a sectional view of a zoom lens according to Example 1 in an in-focus state at infinity at a wide-angle end.

FIGS. 2A and 2B are longitudinal aberration diagrams of the zoom lens according to Example 1 in the in-focus state at infinity at the wide-angle end and a telephoto end.

FIG. 3 illustrates an image stabilizing residue amount in the case of image stabilization by ±0.4 degrees in an image pickup apparatus having the zoom lens according to Example 1.

FIG. 4 is a sectional view of a zoom lens according to Example 2 in an in-focus state at infinity at a wide-angle end.

FIGS. 5A and 5B are longitudinal aberration diagrams of the zoom lens according to Example 2 in the in-focus state at infinity at the wide-angle end and a telephoto end.

FIG. 6 illustrates an image stabilizing residue amount in the case of image stabilization by ±0.4 degrees in an image pickup apparatus having the zoom lens according to Example 2.

FIG. 7 is a sectional view of a zoom lens according to Example 3 in an in-focus state at infinity at a wide-angle end.

FIGS. 8A and 8B are longitudinal aberration diagrams of the zoom lens according to Example 3 in the in-focus state at infinity at the wide-angle end and a telephoto end.

FIG. 9 illustrates an image stabilizing residue amount in the case of image stabilization by ±0.4 degrees in an image pickup apparatus having the zoom lens according to Example 3.

FIG. 10 is a sectional view of a zoom lens according to Example 4 in an in-focus state at infinity at a wide-angle end.

FIGS. 11A and 11B are longitudinal aberration diagrams of the zoom lens according to Example 4 in the in-focus state at infinity at the wide-angle end and a telephoto end.

FIG. 12 illustrates an image stabilizing residue amount in the case of image stabilization by ±0.4 degrees in an image pickup apparatus having the zoom lens according to Example 4.

FIG. 13 is a sectional view of a zoom lens according to Example 5 in an in-focus state at infinity at a wide-angle end.

FIGS. 14A and 14B are longitudinal aberration diagrams of the zoom lens according to Example 5 in the in-focus state at infinity at the wide-angle end and a telephoto end.

FIG. 15 illustrates an image stabilizing residue amount in the case of image stabilization by ±0.4 degrees in an image pickup apparatus having the zoom lens according to Example 5.

FIG. 16 is a sectional view of a zoom lens according to Example 6 in an in-focus state at infinity at a wide-angle end.

FIGS. 17A and 17B are longitudinal aberration diagrams of the zoom lens according to Example 6 in the in-focus state at infinity at the wide-angle end and a telephoto end.

FIG. 18 illustrates an image stabilizing residue amount in the case of image stabilization by ±0.4 degrees in an image pickup apparatus having the zoom lens according to Example 6.

FIG. 19 is a sectional view of a zoom lens according to Example 7 in an in-focus state at infinity at a wide-angle end.

FIGS. 20A and 20B are longitudinal aberration diagrams of the zoom lens according to Example 7 in the in-focus state at infinity at the wide-angle end and a telephoto end.

FIG. 21 illustrates an image stabilizing residue amount in the case of image stabilization by ±0.4 degrees in an image pickup apparatus having the zoom lens according to Example 7.

FIG. 22 is a sectional view of a zoom lens according to Example 8 in an in-focus state at infinity at a wide-angle end.

FIGS. 23A and 23B are longitudinal aberration diagrams of the zoom lens according to Example 8 in the in-focus state at infinity at the wide-angle end and a telephoto end.

FIG. 24 illustrates an image stabilizing residue amount in the case of image stabilization by ±0.4 degrees in an image pickup apparatus having the zoom lens according to Example 8.

FIG. 25 is a sectional view of a zoom lens according to Example 9 in an in-focus state at infinity at a wide-angle end.

FIGS. 26A and 26B are longitudinal aberration diagrams of the zoom lens according to Example 9 in the in-focus state at infinity at the wide-angle end and a telephoto end.

FIG. 27 illustrates an image stabilizing residue amount in the case of image stabilization by ±0.4 degrees in an image pickup apparatus having the zoom lens according to Example 9.

FIG. 28 is a sectional view of a zoom lens according to Example 10 in an in-focus state at infinity at a wide-angle end.

FIGS. 29A and 29B are longitudinal aberration diagrams of the zoom lens according to Example 10 in the in-focus state at infinity at the wide-angle end and a telephoto end.

FIG. 30 illustrates an image stabilizing residue amount in the case of image stabilization by ±0.4 degrees in an image pickup apparatus having the zoom lens according to Example 10.

FIG. 31 is a sectional view of a zoom lens according to Example 11 in an in-focus state at infinity at a wide-angle end.

FIGS. 32A and 32B are longitudinal aberration diagrams of the zoom lens according to Example 11 in the in-focus state at infinity at the wide-angle end and a telephoto end.

FIG. 33 illustrates an image stabilizing residue amount in the case of image stabilization by ±0.4 degrees in. an image pickup apparatus having the zoom lens according to Example 11.

FIG. 34 is a schematic diagram of the image pickup apparatus.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

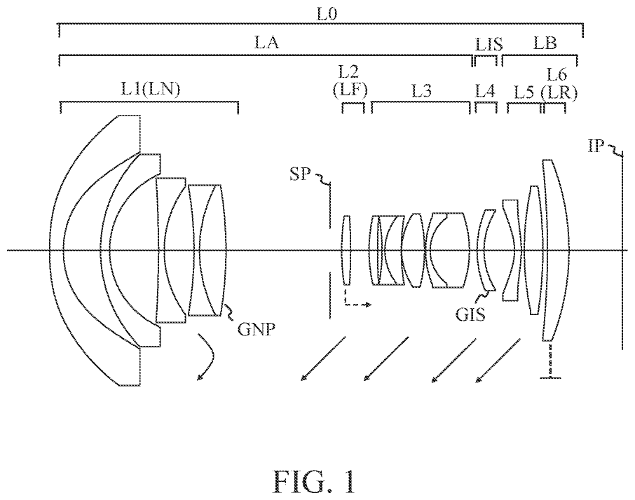

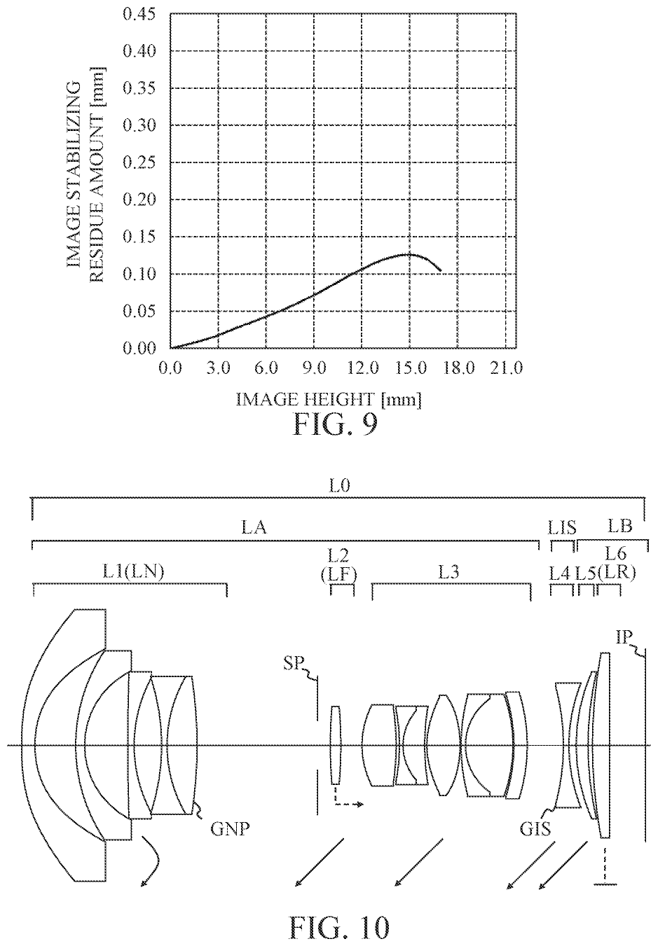

FIGS. 1, 4, 7, 10, 13, 16, 19, 22, 25, 28, and 31 sectional views of zoom lenses L0 according to Examples 1 to 11 in an in-focus state at infinity at a wide-angle end. The zoom lens L0 according to each example is used for an optical apparatus including an interchangeable lens and an image pickup apparatus, such as a digital video camera, a digital still camera, a broadcasting camera, a film-based camera, and a surveillance camera.

In each sectional view, a left side is an object side and a right side is an image side. The zoom lens L0 according to each example includes a plurality of lens units. In this specification, a lens unit is a group of lenses that integrally move or stand still during zooming. That is, in the zoom lens L0 according to each example, a distance between adjacent lens units changes during zooming. The lens unit may include one or more lenses. The lens unit may include an aperture stop.

The zoom lens L0 according to each example includes, in order from the object side to the image side, a front group LA including a plurality of lens units, an image stabilizing unit LIS having negative refractive power (where optical power is a reciprocal of focal length), and a rear group LB including one or more lens units. In each sectional view, Li represents an i-th lens unit (where i is a natural number) counted from the object side among the lens units included in the zoom lens L0. The front group LA includes all lens units disposed on the object side of the image stabilizing unit LIS. The front group LA includes a focus unit LF that moves during focusing from infinity to a close (short distance) distance (object), and a lens unit LN having negative refractive power. The image stabilizing unit LIS corrects image blur (performs image stabilization) by moving in a direction that includes a component orthogonal to the optical axis. The rear group LB includes all lens units disposed on the image side of the image stabilizing unit LIS. The rear group LB includes a lens unit LR closest to the image plane of the zoom lens L0.

SP represents an aperture stop, which determines (limits) the light beam of the minimum F-number (Fno) (maximum aperture). IP represents an image plane. In a case where the zoom lens L0 according to each example is used as an imaging optical system for a digital still camera or a digital video camera, an imaging surface of a solid-state image sensor (photoelectric conversion element) such as a CCD sensor or a CMOS sensor is placed on the image plane IP. In a case where the zoom lens L0 according to each example is used as an imaging optical system of a film-based camera, a photosensitive surface corresponding to the film surface is placed on the image plane IP.

In the zoom lens L0 according to each example, distances on the front side and on the rear side of the image stabilizing unit LIS are fixed or changes during zooming from the wide-angle end to the telephoto end. In the front group LA and the rear group LB, a distance between adjacent lens units changes during zooming from the wide-angle end to the telephoto end. During zooming from the wide-angle end to the telephoto end, a distance on the optical axis from a lens surface of the lens unit LN closest to the image plane to the aperture stop SP becomes narrower. At the wide-angle end, the distance on the optical axis from the lens surface closest to the image plane of the lens unit LN to the aperture stop SP is a maximum distance among the distances on the optical axis between the lens units included in the zoom lens L0. A solid arrow illustrated in each sectional view represents a moving direction of each lens unit during zooming from the wide-angle end to the telephoto end. A broken arrow illustrated in each sectional view represents a moving direction of the lens unit during focusing from infinity to a close distance.

In this specification, the wide-angle end and the telephoto end refer to zoom positions where each lens unit is mechanically located at both ends of a movable range on the optical axis.

In the zoom lens L0 according to each example, a parallel plate having substantially no refractive power, such as a lowpass filter or an infrared cut filter, may be disposed between the lens disposed closest to the image plane and the image plane IP.

The zoom lens L0 according to each example may include a memory storing distortion correction data for correcting distortion.

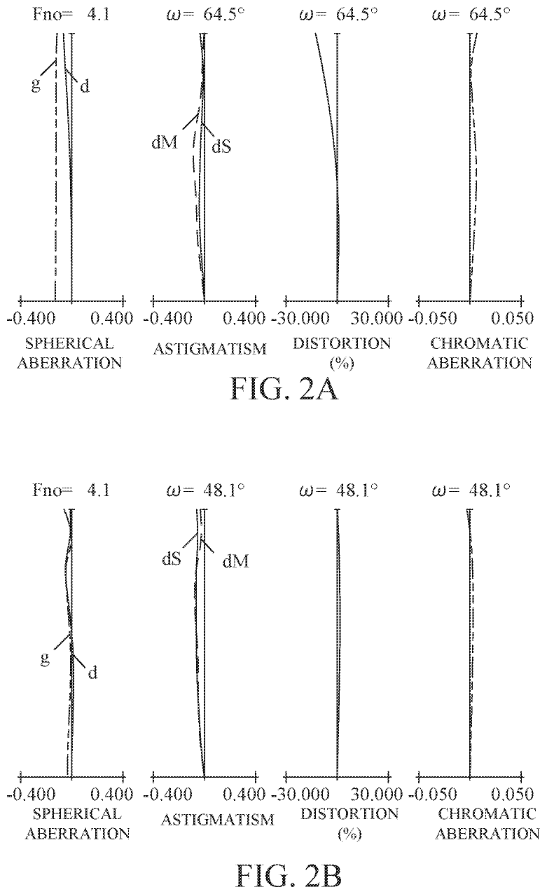

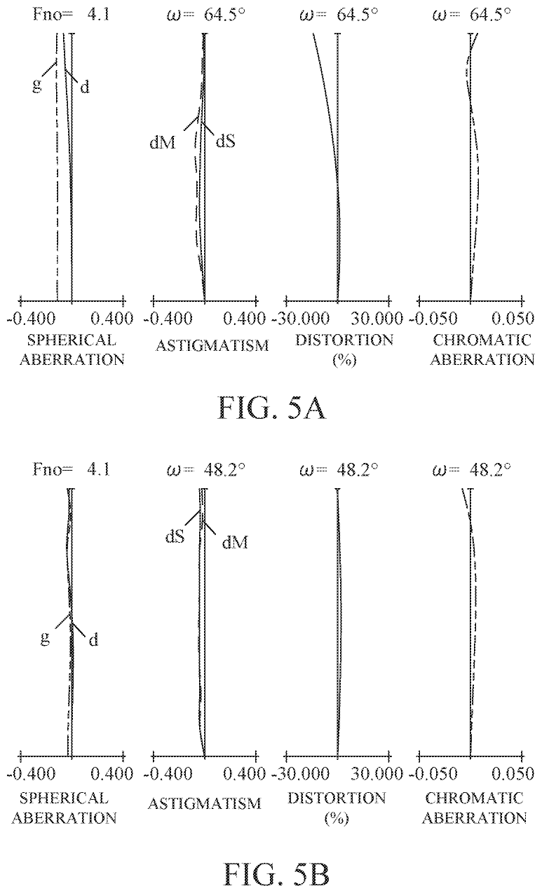

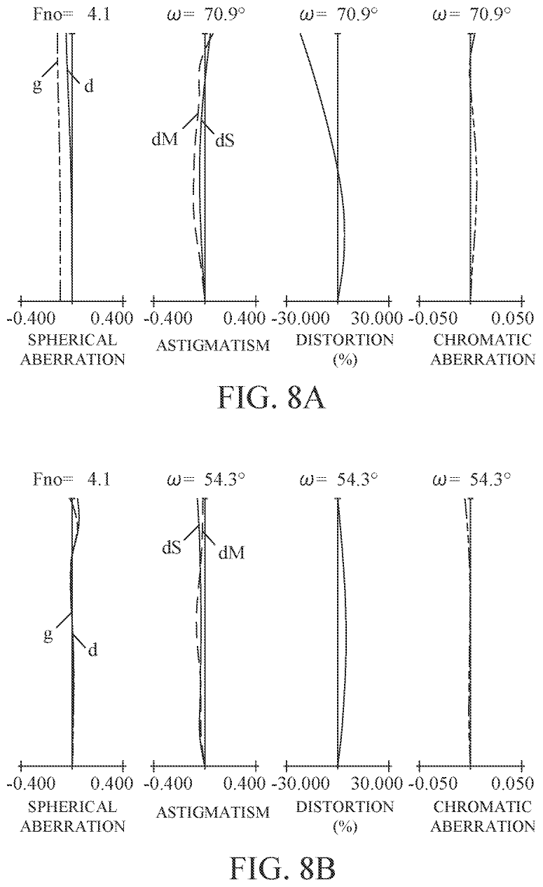

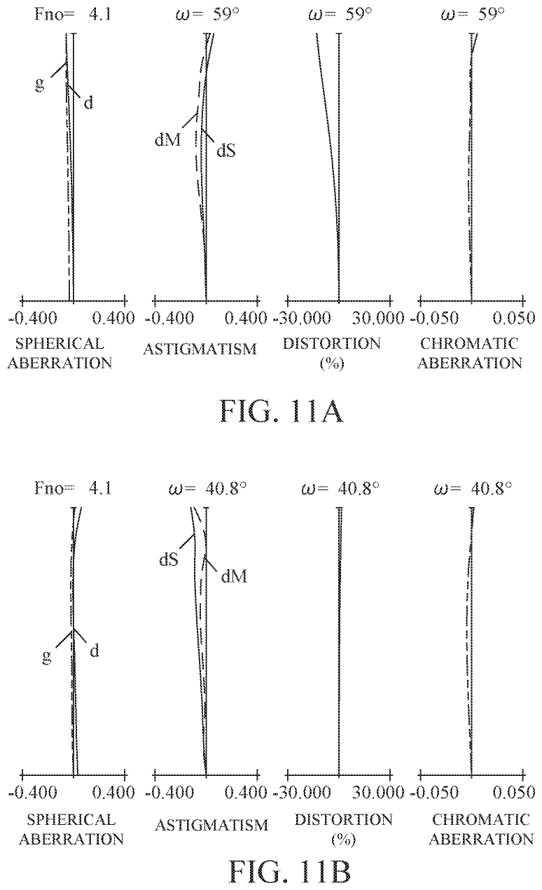

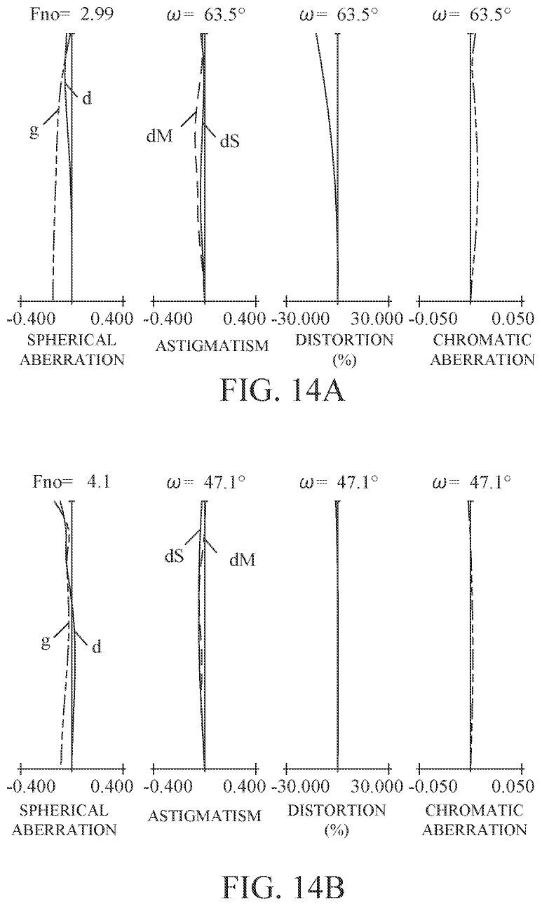

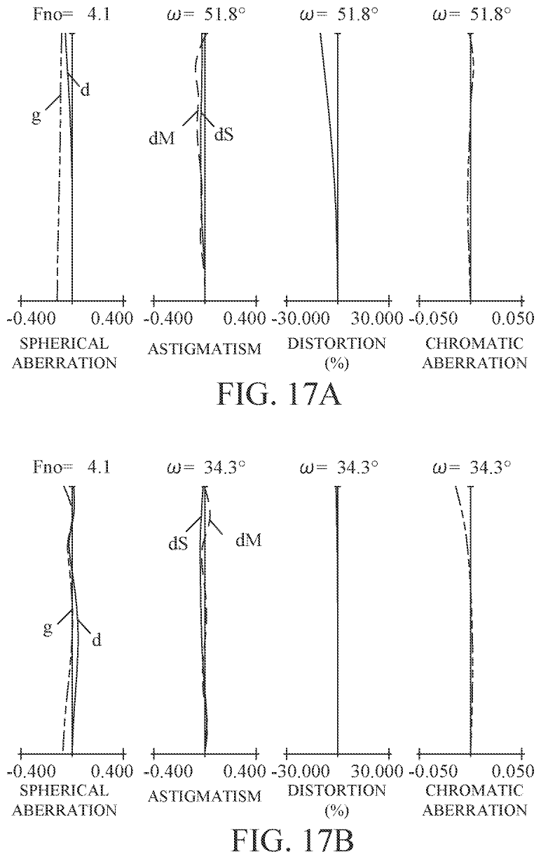

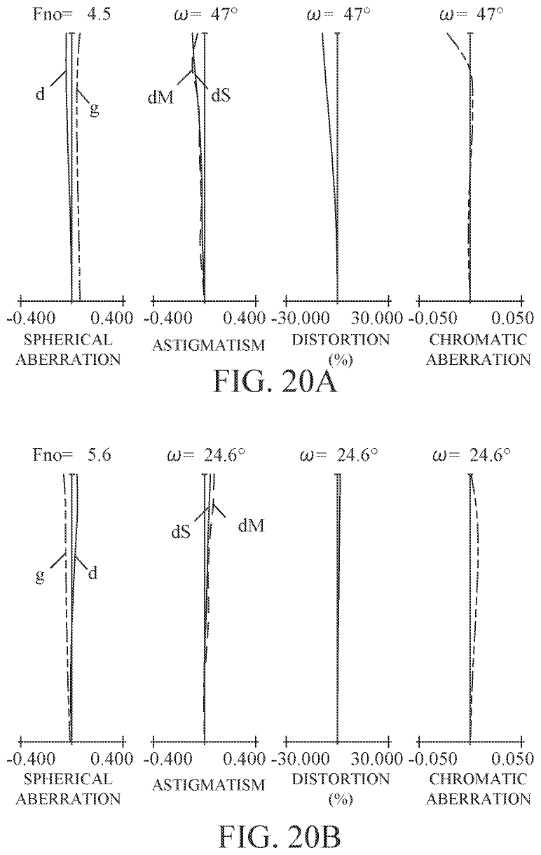

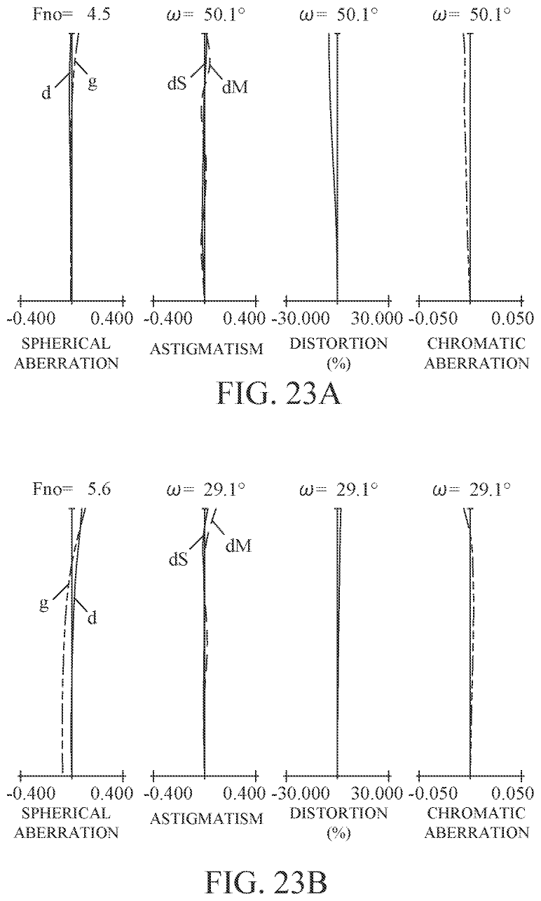

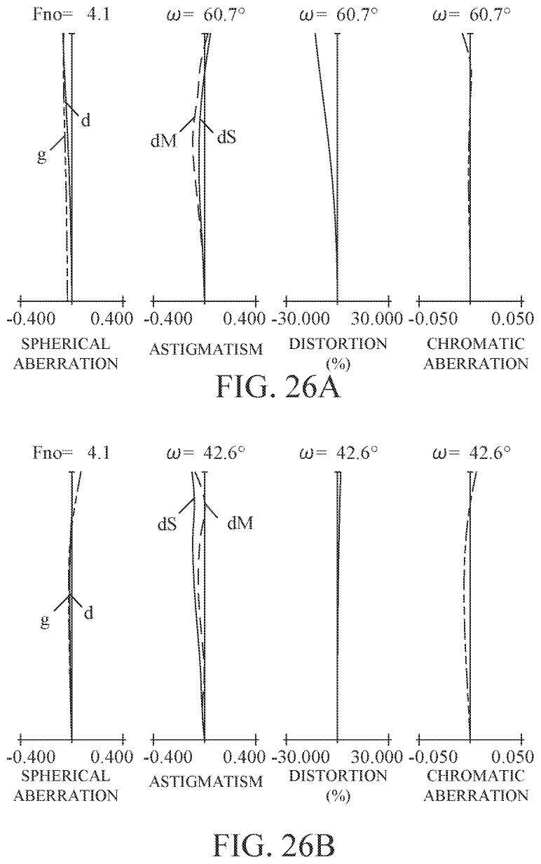

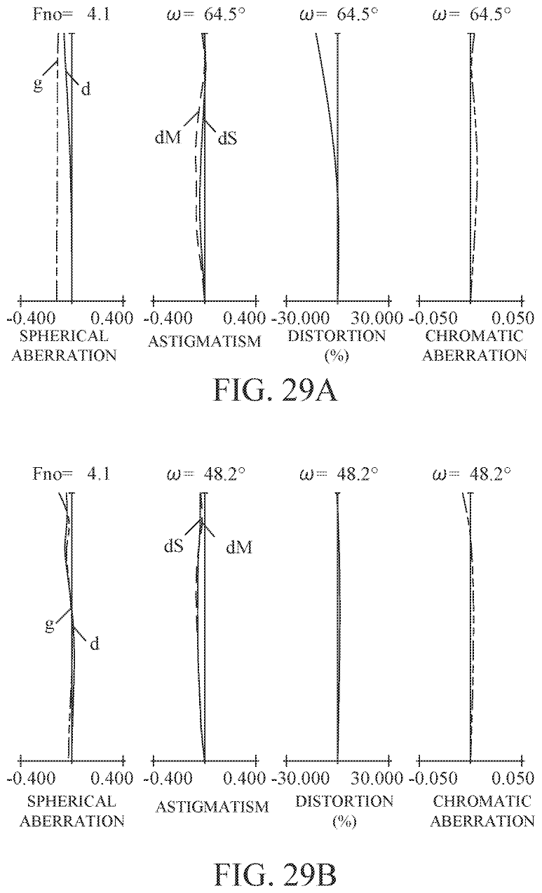

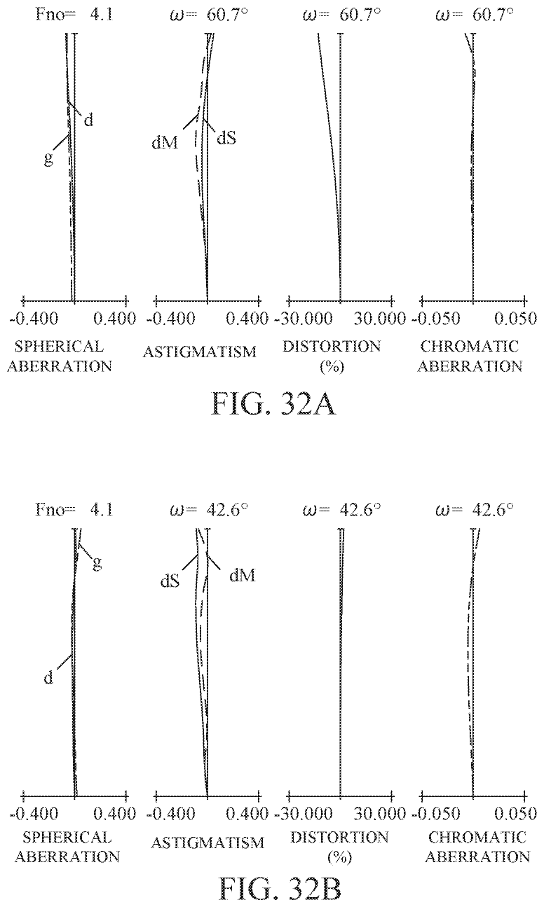

FIGS. 2A, 5A, 8A, 11A, 14A, 17A, 20A, 23A, 26A, 29A, and 32A are longitudinal aberration diagrams of the zoom lenses according to Examples 1 to 11 in the in-focus state at infinity at the wide-angle end. FIGS. 2B, 5B, 8B, 11B, 14B, 17B, 20B, 23B, 26B, 29B, and 32B are longitudinal aberration diagrams of the zoom lenses according to Examples 1 to 11 in the in-focus state at infinity at the telephoto end.

In a spherical aberration diagram, Fno represents an F-number. The spherical aberration diagram illustrates spherical aberration amounts for the d-line (wavelength 587.6 nm) and the g-line (wavelength 435.8 nm). In an astigmatism diagram, dS represents an astigmatism amount on a sagittal image plane, and dM represents an astigmatism amount on a meridional image plane. A distortion diagram illustrates a distortion amount for the d-line. A chromatic aberration diagram illustrates a chromatic aberration amount for the g-line. ω is an imaging half angle of view (°), which is the angle of view based on an actual ray.

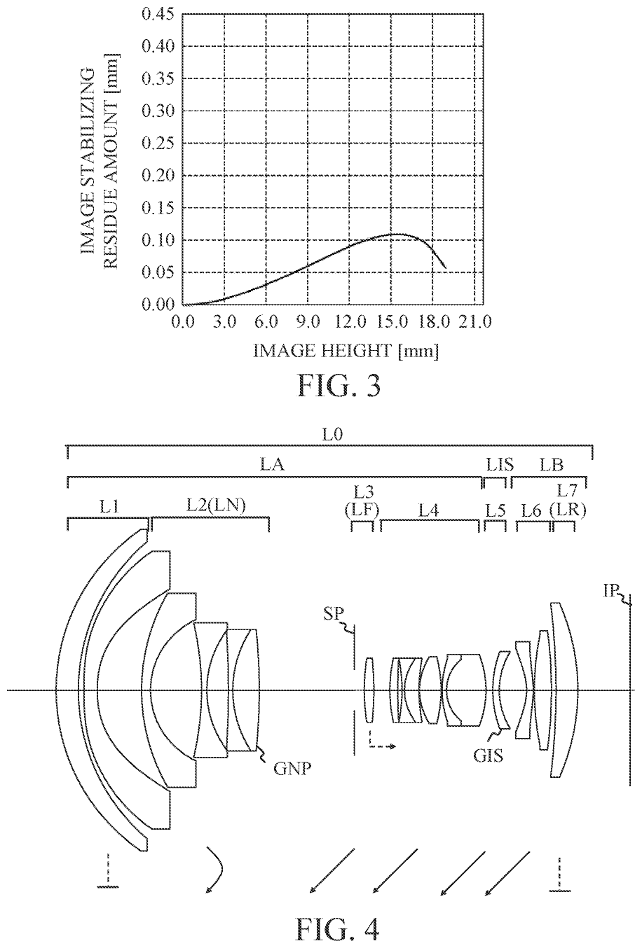

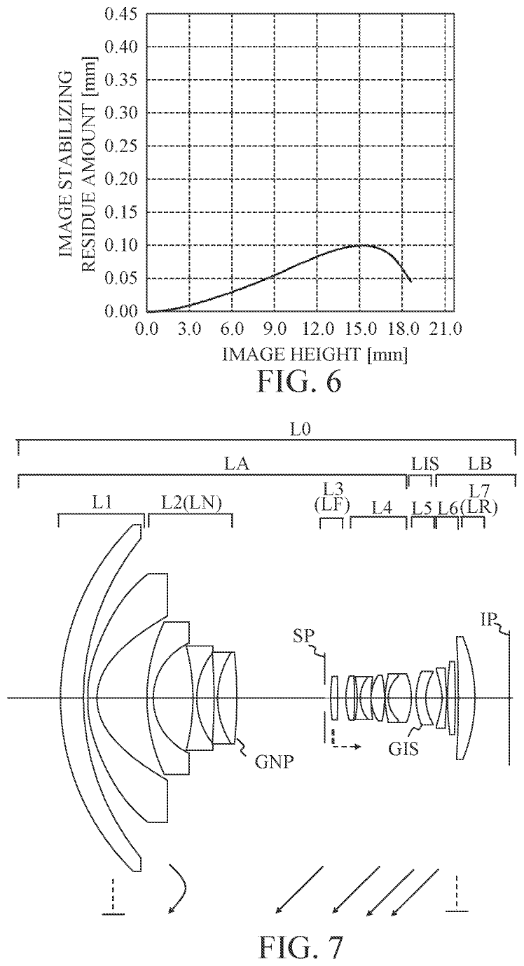

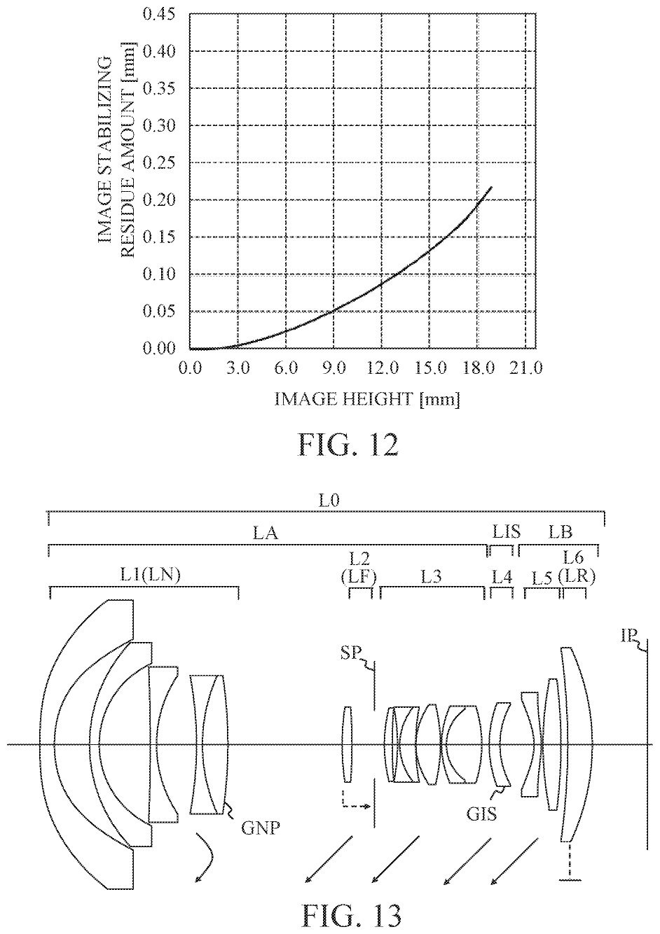

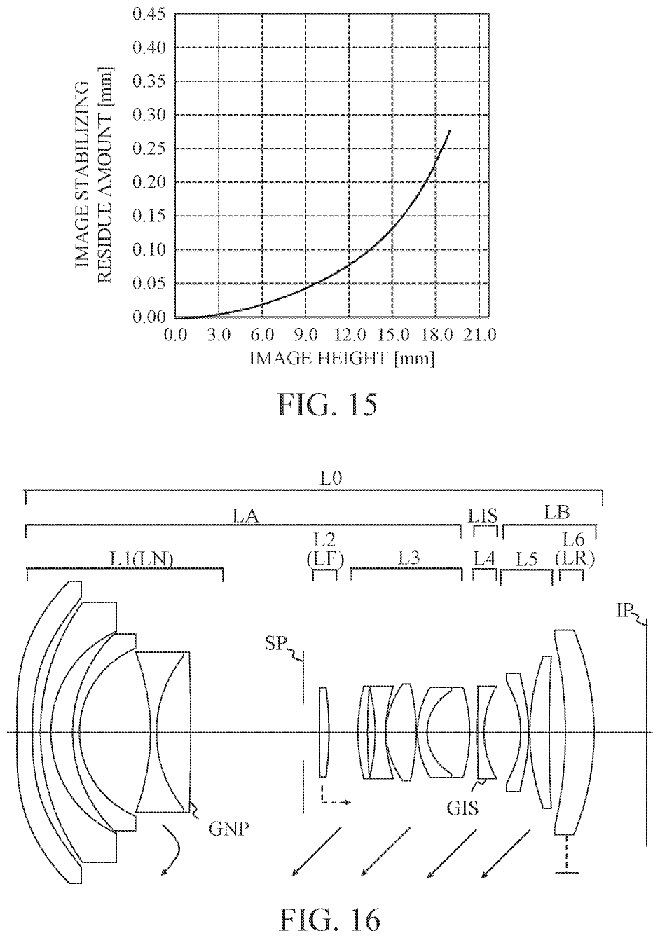

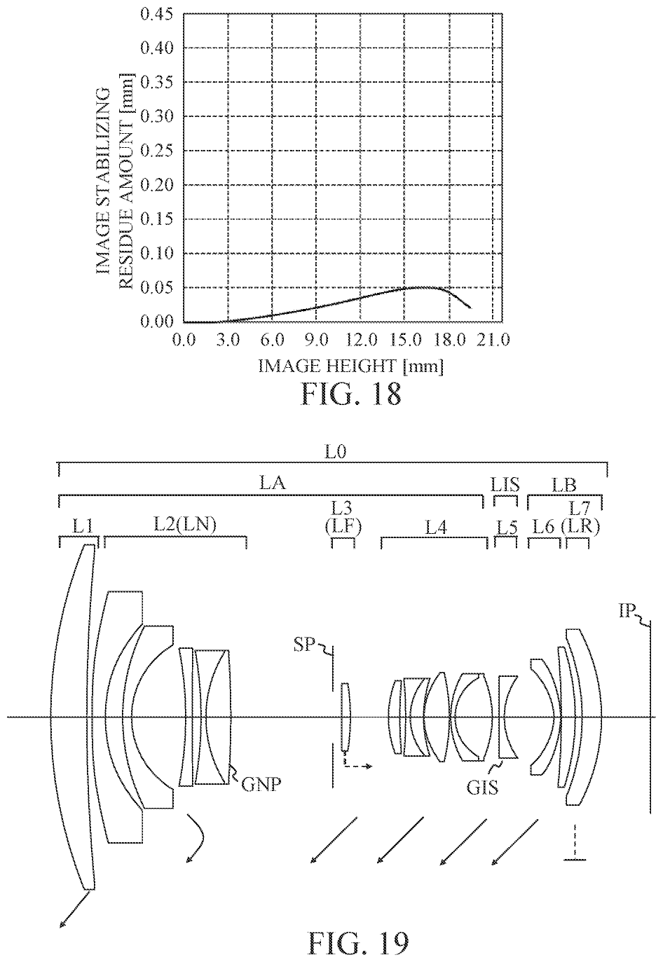

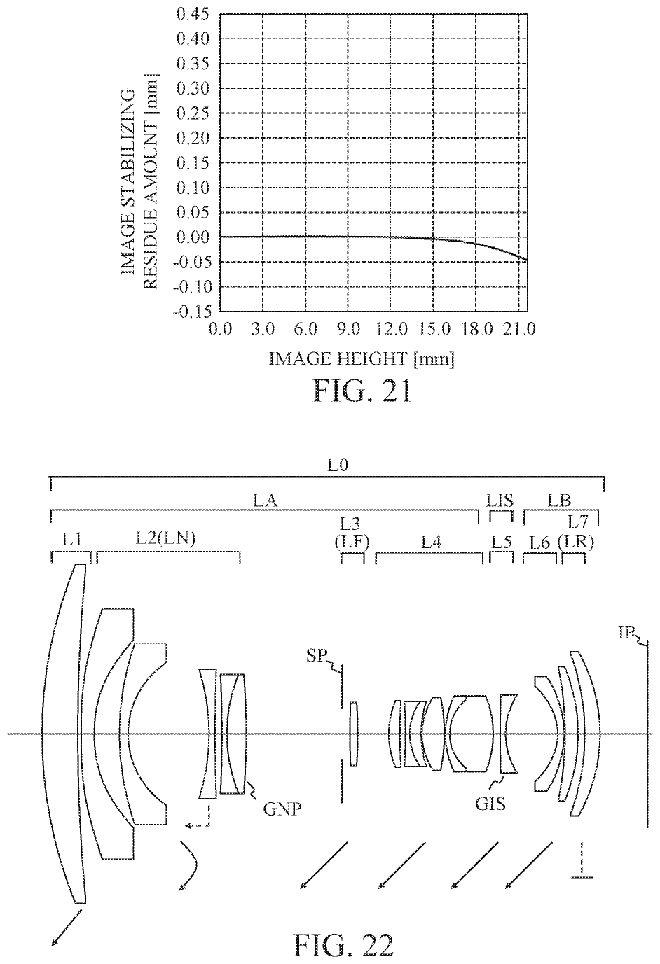

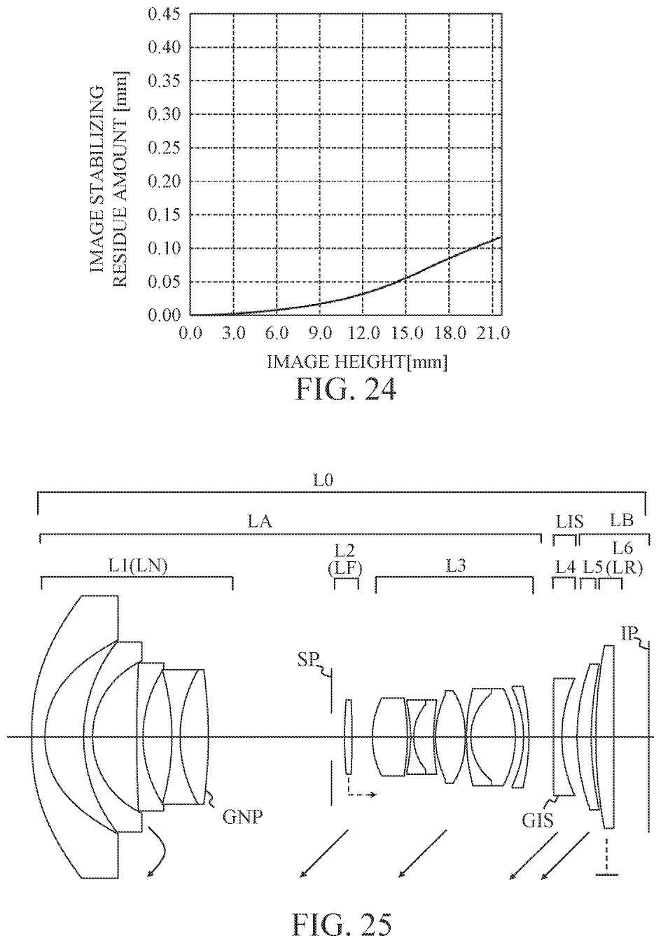

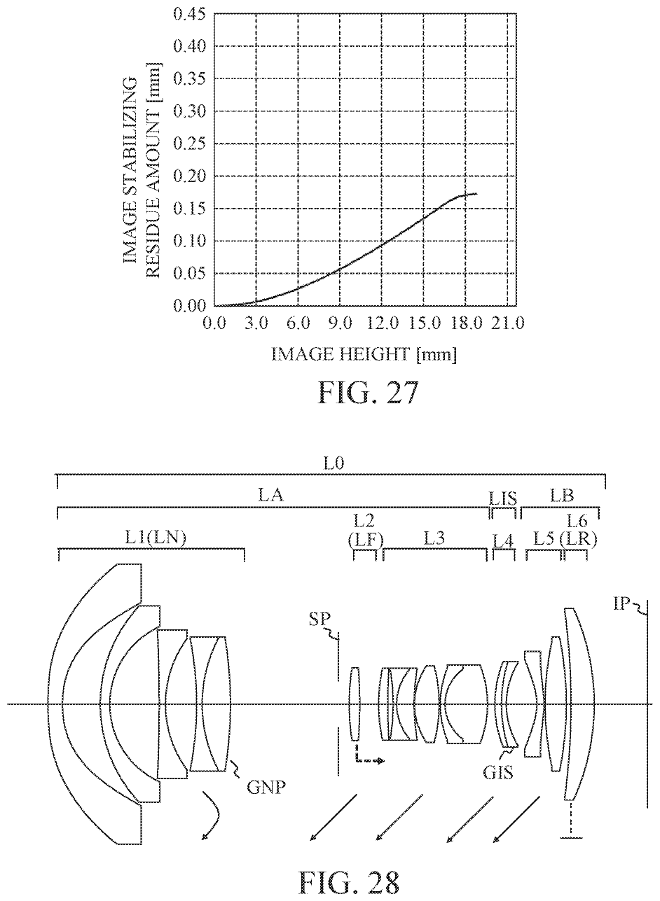

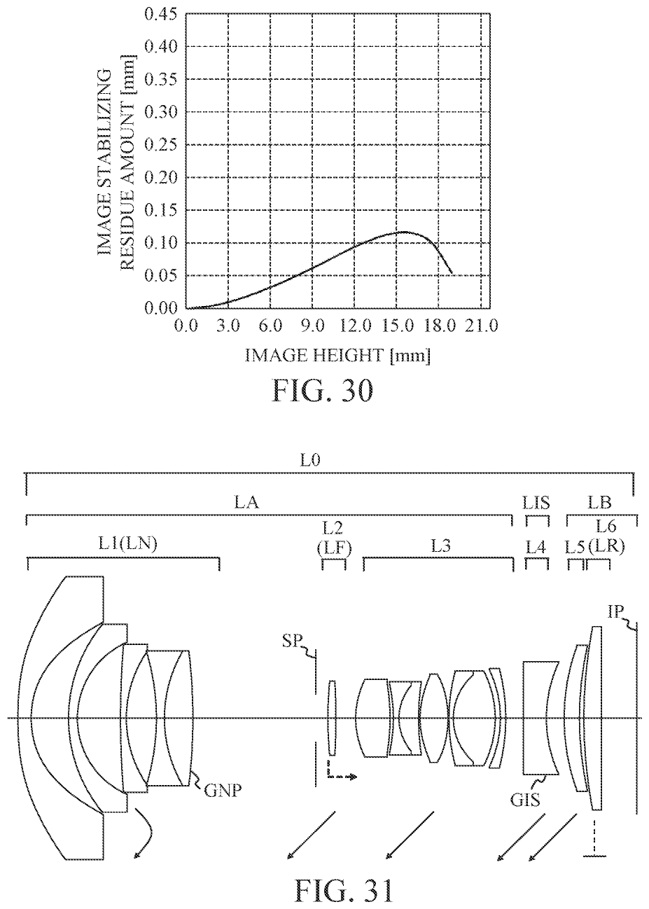

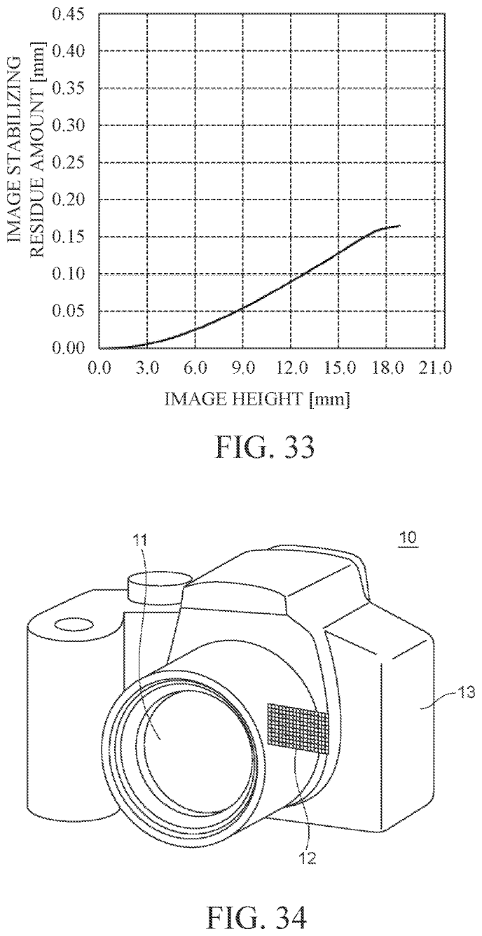

FIGS. 3, 6, 9, 12, 15, 18, 21, 24, 27, 30, and 33 illustrate image stabilizing residue amounts in the case of image stabilization by 0.4 degrees. The image stabilizing residue amount has a value of the zoom lens L0 in the in-focus state at infinity at the wide-angle end, and it is an image stabilizing residue amount for each image height in a case where the image stabilizing unit LIS performs correction of image blur at the central portion of the image that has occurred by tilting the image pickup apparatus.

A description will now be given of the characteristic configuration of the zoom lens L0 according to each example.

The zoom lens L0 according to each example includes, in order from the object side to the image side, the front group LA including a plurality of lens units, the image stabilizing unit LIS having negative refractive power, and the rear group LB including one or more lens units. Disposing the lens units before and after the image stabilizing unit LIS can suppress coma and one-sided blur during image stabilization.

The front group LA includes the focus unit LF and the aperture stop SP. Placing the image stabilizing unit LIS on the image side of the aperture stop SP can cancel out distortion changes during image stabilization and image blur in the peripheral portion of the image. Placing the focus unit LF near the aperture stop SP and reducing the height of an off-axis ray incident on the focus unit LF can easily reduce the size of the focus mechanism.

In general, in a case where a lens unit in which an off-axis ray is high is moved in a direction that includes a component orthogonal to the optical axis, the influence on the peripheral portion of the image is significant. Therefore, if the height of the off-axis ray incident on the image stabilizing unit LIS is high, the distortion change that occurs during image stabilization becomes large, and it becomes easy to suppress image blur in the peripheral portion of the image. On the other hand, if the height of the off-axis ray incident on the image stabilizing unit LIS is high, the lens diameter becomes larger. Therefore, in order to reduce the size of the image stabilizing unit LIS and suppress image blur in the peripheral portion of the image, the image stabilizing unit LIS is disposed at a proper position.

In addition, setting a large angle of view and increasing the distortion generated in each lens unit can easily suppress image blur in the peripheral portion of the image.

Accordingly, the zoom lens L0 according to each example properly sets the angle of view and arrangement of the focus unit LF, aperture stop SP, and image stabilizing unit LIS. More specifically, the zoom lens L0 according to each example satisfies the following inequalities (1) and (2).

$$0.4 < DIS w / DSP w < 0.8 \qquad ( 1 )$$

$$43.2 ° < ω w < 90. ° \qquad ( 2 )$$

Where DISw is a distance on the optical axis from the aperture stop SP to a lens surface on the object side of the image stabilizing unit LIS at the wide-angle end, DSPw is a distance on the optical axis from the aperture stop SP to the image plane at the wide-angle end, and ωw [°] is a half angle of view of the zoom lens L0 at the wide-angle end.

Inequality (1) defines a relationship between the distance on the optical axis from the aperture stop SP to the lens surface on the object side of the image stabilizing unit LIS at the wide-angle end, and the distance on the optical axis from the aperture stop SP to the image plane at the wide-angle end. Satisfying inequality (1) can reduce the diameter of the image stabilizing unit LIS and easily dispose driving units for moving the image stabilizing unit LIS and the focus unit LF. In a case where the distance on the optical axis from the aperture stop SP to the lens surface on the object side of the image stabilizing unit LIS becomes too short and the value becomes lower than the lower limit of inequality (1), the height of off-axis ray incident on the image stabilizing unit LIS becomes lower and it becomes difficult to suppress image blur in the peripheral portion of the image. In a case where the distance on the optical axis from the aperture stop SP to the lens surface on the object side of the image stabilizing unit LIS becomes too long and the value becomes higher than the upper limit of inequality (1), the height of off-axis rays incident on the image stabilizing unit LIS becomes high. Therefore, it becomes difficult to reduce the diameter of the image stabilizing unit LIS, and it becomes difficult to reduce the size of the zoom lens L0.

Inequality (2) defines the half angle of view of the zoom lens L0 at the wide-angle end. Satisfying inequality (2) can increase the distortion generated in each lens unit and facilitates suppression of image blur in the peripheral portion of the image. In a case where the value becomes lower than the lower limit of inequality (2), the distortion generated in each lens unit becomes small and it becomes difficult to suppress image blur in the peripheral portion of the image. In a case where the value becomes higher than the upper limit of inequality (2), the distortion of the entire zoom lens L0 becomes large and it becomes difficult to maintain excellent optical characteristics.

The above configuration can realize a zoom lens that is small and has excellent optical characteristics even during image stabilization.

Inequalities (1) and (2) may be replaced with inequalities (1a) and (2a) below:

$$0.41 < DIS w / DSP w < 0.78 \qquad ( 1 a )$$

$$45. ° < ω w < 80. ° \qquad ( 2 a )$$

Inequalities (1) and (2) may be replaced with inequalities (1b) and (2b) below:

$$0.42 < DIS w / DSP w < 0.76 \qquad ( 1 b )$$

$$46. ° < ω w < 71. ° \qquad ( 2 b )$$

A description will now be given of the configurations that may be satisfied by the zoom lens Z0 according to each example.

The lens unit LN may include, in order from the object side to the image side, a plurality of negative meniscus lenses having convex surfaces facing the object side. Thereby, a sufficiently wide angle can be secured.

The lens unit LN may include, in order from the object side to the image side, four or more negative lenses and one or more positive lenses. This configuration can achieve a sufficiently wide angle and a sufficient magnification varying ratio.

The focus unit LF may include a single lens. Thereby, the size of the focus mechanism can be reduced, and the size of the zoom lens L0 can be reduced.

The aperture stop SP may be disposed adjacent to and on the image side of the lens unit LN and moves toward the object side during zooming from the wide-angle end to the telephoto end. This configuration facilitates miniaturization of the aperture stop SP.

The image stabilizing unit LIS may consist of two or less lenses. This configuration can reduce the size of the image stabilizing mechanism, and the size of the zoom lens L0. The image stabilizing unit LIS may consist of a single lens.

In moving the image stabilizing unit LIS, the image sensor provided in the image pickup apparatus having the zoom lens L0 may be moved by a second image stabilizing unit. Combining a so-called sensor shift-type image stabilization mechanism that moves the image sensor can easily suppress image blur in the peripheral portion of the image.

A description will now be given of conditions that may be satisfied by the zoom lens Z0 according to each example. The zoom lens Z0 according to each example may satisfy one or more of the following inequalities (3) to (15):

$$25 < ν dF < 100 \qquad ( 3 )$$

$$0.2 < DLFw / TLw < 0.7 \qquad ( 4 )$$

$$0.03 < Skw / TLw < 0.2 \qquad ( 5 )$$

$$- 0.45 < fLN / fLF < - 0.15 \qquad ( 6 )$$

$$0. < \vert fLN / fLR \vert < 0.4 \qquad ( 7 )$$

$$0.5 < \vert fLR / fLIS \vert < 11. \qquad ( 8 )$$

$$1.4 < ndF < 1.91 \qquad ( 9 )$$

$$20 < ν dGIS < 80 \qquad ( 10 )$$

$$22 < ν GNP < 50 \qquad ( 11 )$$

$$0. < ( R 1 + R 2 ) / ( R 1 - R 2 ) < 13. \qquad ( 12 )$$

$$- 1.6 < Ymax\_w / fLN < - 0.4 \qquad ( 13 )$$

$$- 40 < Dist\_w < 0 \qquad ( 14 )$$

$$0.1 < Φ IS / Φ R < 0.8 \qquad ( 15 )$$

Here, νdF is a maximum value of an Abbe number based on the d-line among lenses included in the focus unit LF. DLFw is a distance on the optical axis from a lens surface of the zoom lens L0 closest to the object at the wide-angle end to a lens surface of the focus unit LF closest to the object at the wide-angle end. TLw is a distance on the optical axis from the lens surface closest to the object of the zoom lens L0 to the image plane IP at the wide-angle end (overall lens length). Skw is a back focus at the wide-angle end. fLN is a focal length of lens unit LN. fLF is a focal length of the focus unit LF. fLR is a focal length of lens unit LR. fLIS is a focal length of the image stabilizing unit LIS. ndF is a maximum value of the refractive index for the d-line of the lens included in the focus unit LF. νdGIS is an Abbe number based on the d-line of the negative lens GIS included in the image stabilizing unit LIS. νdGNP is an Abbe number based on the d-line of the positive lens GNP, which has the strongest refractive power among the positive lenses included in the lens unit LN. R1 is a radius of curvature of a lens surface closest to the object of the image stabilizing unit LIS. R2 is a radius of curvature of a lens surface closest to the image plane of the image stabilizing unit LIS. Ymax_w is a maximum image height in the in-focus state at infinity at the wide-angle end. The maximum image height is a distance from the optical axis of the image point farthest from the optical axis among image points that can be imaged, and a magnification change due to the distortion amount is taken into consideration in each example. Dist_w is a distortion amount at the maximum image height in the in-focus state at infinity at the wide-angle end. ΦIS is a maximum effective diameter among lenses included in the image stabilizing unit LIS. ΦR is a maximum effective diameter of lenses included in the lens unit LR. The effective diameter of the lens is a diameter of a circle whose radius is a height from the optical axis of a light ray that passes the position farthest from the optical axis among light rays that pass through the lens surface. The effective diameter may be a diameter defined by a circle inscribed on a lens surface by a mechanical member such as a press ring or crimping claw, or a diameter of a circle made by connecting the outermost peripheral portions on a surface generally formed by polishing or molding if no mechanical member is arranged.

Inequality (3) defines the maximum value of the Abbe number based on the d-line of the lens included in the focus unit LF. In a case where the value becomes lower than the lower limit of inequality (3), it becomes difficult to suppress chromatic aberration fluctuations during focusing. In a case where the value becomes higher than the upper limit of inequality (3), the refractive index becomes lower, the curvature of the lens becomes steeper, and it becomes difficult to suppress fluctuations in various aberrations including astigmatism during focusing.

Inequality (4) defines a relationship between the distance on the optical axis from the lens surface closest to the object of the zoom lens L0 to the lens surface closest to the object of the focus unit LF at wide-angle and the overall lens length at the wide-angle end. In a case where the value becomes lower than the lower limit of inequality (4) and the focus unit LF becomes too close to the object, the height of off-axis ray incident on the focus unit LF becomes high, and it becomes difficult to reduce the size of the focus unit LF. In a case where the value becomes higher than the upper limit of inequality (4) and the focus unit LF becomes too close to the image plane, the height of off-axis ray incident on the focus unit LF becomes high, and it becomes difficult to reduce the size of the focus unit LF.

Inequality (5) defines a relationship between the back focus at the wide-angle end and the overall lens length at the wide-angle end. In a case where the back focus becomes shorter and the value becomes lower than the lower limit of inequality (5), it becomes difficult to dispose an optical element such as a lowpass filter near the image sensor configured to photoelectrically convert an optical image formed by the zoom lens L0. In a case where the back focus becomes longer and the value becomes higher than the upper limit of inequality (5), the overall lens length at the wide-angle end becomes longer, and it becomes difficult to reduce the size of the zoom lens L0.

Inequality (6) defines a relationship between the focal length of the lens unit LN and the focal length of the focus unit LF. In a case where the refractive power of the lens unit LN becomes lower and the value becomes lower than the lower limit of inequality (6), it becomes difficult to achieve a wide angle. Moreover, the diameter of the front lens becomes larger, and the outer diameter of the lens becomes larger. In a case where the refractive power of the lens unit LN becomes stronger and the value becomes higher than the upper limit of inequality (6), the asymmetry of the refractive power arrangement of the zoom lens L0 becomes stronger, and it becomes difficult to correct distortion at the wide-angle end.

Inequality (7) defines a relationship between the focal length of the lens unit LN and the focal length of the lens unit LR. Satisfying inequality (7) can achieve both miniaturization and high image quality. In a case where the positive refractive power of the lens unit LR becomes stronger and the value becomes lower than the lower limit of inequality (7), the retrofocus refractive power arrangement becomes stronger, the asymmetry of the refractive power arrangement of the zoom lens L0 becomes stronger, and it becomes difficult to correct distortion. Furthermore, it becomes difficult to reduce the overall lens length at the wide-angle end. In a case where the negative refractive power of the lens unit LR becomes stronger and the value becomes higher than the upper limit of inequality (7), it becomes difficult to achieve a retrofocus refractive power arrangement, it becomes difficult to achieve a retrofocus refractive power arrangement, to secure a back focus at the wide-angle end, and to widen the imaging angle of view.

Inequality (8) defines a relationship between the focal length of the lens unit LR and the focal length of the image stabilizing unit LIS. In a case where the refractive power of the image stabilizing unit LIS becomes weaker and the value becomes lower than the lower limit of inequality (8), a moving amount of the image stabilizing unit LIS during image stabilization becomes too large, and it becomes difficult to reduce the outer diameter of the lens. In a case where the refractive power of the image stabilizing unit LIS becomes stronger and the value becomes higher than the upper limit of inequality (8), it becomes difficult to suppress fluctuations in coma and one-sided blur during image stabilization.

Inequality (9) defines the refractive index for the d-line of the lens included in the focus unit LF. In a case where the value becomes lower than the lower limit of inequality (9), the curvature of the lens becomes steep in order to provide the refractive power necessary for focusing, and it becomes difficult to suppress fluctuations in various aberrations including astigmatism. In a case where the value becomes higher than the upper limit of inequality (9), the curvature of the lens becomes loose, and it becomes difficult to suppress fluctuations in various aberrations including spherical aberration during focusing.

Inequality (10) defines the Abbe number νdGIS based on the d-line of the negative lens GIS included in the image stabilizing unit LIS. In a case where the value becomes lower than the lower limit of inequality (10), it becomes difficult to correct lateral chromatic aberration during image stabilization. In a case where the value becomes higher than the upper limit of inequality (10), the refractive index of the negative lens GIS becomes lower, a moving amount of the image stabilizing unit LIS during image stabilization becomes too large, and it becomes difficult to reduce the outer diameter of the lens.

Inequality (11) defines the Abbe number based on the d-line of the positive lens GNP, which has the strongest refractive power among positive lenses included in the lens unit LN. In a case where the value becomes lower than the lower limit of inequality (11), it becomes difficult to correct lateral chromatic aberration during zooming. In a case where the upper limit of inequality (11), it becomes difficult to correct longitudinal chromatic aberration during zooming.

Inequality (12) defines the shape of the image stabilizing unit LIS. The image stabilizing unit LIS has a meniscus shape with a convex surface facing the object side, and suppresses fluctuations in coma during image stabilization. In a case where the value becomes lower than the lower limit of inequality (12), it becomes difficult to suppress fluctuations in coma during image stabilization. In a case where the value becomes higher than the upper limit of inequality (12), it becomes difficult to suppress fluctuations in coma during image stabilization.

Inequality (13) defines a relationship between the maximum image height that can be imaged at the wide-angle end and the focal length of the lens unit LN. Satisfying inequality (13) can reduce the size and weight of the zoom lens L0. In a case where the maximum image height decreases and the value becomes lower than the lower limit of inequality (13), the angle of view becomes narrower than the desired imaging angle of view. In a case where the maximum image height increases and the value becomes higher than the upper limit of inequality (13), a light ray in a wider range than the desired imaging angle of view becomes imaged on the imaging plane, the mechanical mechanism etc. becomes larger, and it becomes difficult to reduce the size and weight of the zoom lens L0.

Inequality (14) defines the distortion amount at the maximum image height in the in-focus state at infinity at the wide-angle end. In a case where the value becomes lower than the lower limit of inequality (14), it becomes difficult to suppress peripheral image quality deterioration during electronic distortion correction. In a case where the value becomes higher than the upper limit of inequality (14), the distortion amount in the equidistant projection method is too large, and peripheral image quality significantly deteriorates during image stabilization. Further, even in the image stabilization using the image stabilizing unit LIS, the image stabilizing amount in the peripheral portion of the image becomes insufficient.

The distortion amount will now be defined. A distortion amount Dist_w [%] at an arbitrary image height at the wide-angle end is expressed by the following equation:

$$Dist\_w [ \% ] = ( ( yp - y ) / y 1 ) \times 100$$

where y is an ideal image height in the central projection method, and yp is an actual image height.

The ideal image height y in the central projection method is defined by the following equation:

$$y = f tan θ i$$

where f is a focal length of the optical system, and θi is a half angle of view of the actual ray at an arbitrary image height.

The ideal image height y is expressed by the following equation:

$$y 1 = f tan θ$$

where f is the focal length f of the optical system, and θ is a half angle of view of the actual ray at the maximum image height.

Inequality (15) defines a relationship between the maximum effective diameter of the lens included in the image stabilizing unit LIS and the maximum effective diameter of the lens included in the lens unit LR. In a case where the maximum effective diameter of the lens included in the image stabilizing unit LIS decreases and the value becomes lower than the lower limit of inequality (15), the height of an off-axis ray incident on the image stabilizing unit LIS becomes lower, and it becomes difficult to suppress image blur in the peripheral portion of the image. In a case where the maximum effective diameter of the lens included in the image stabilizing unit LIS increases and the value becomes higher than the upper limit of inequality (15), it becomes difficult to reduce the size of the zoom lens L0.

Inequalities (3) to (15) may be replaced with inequalities (3a) to (15a) below:

$$30 < ν dF < 90 \qquad ( 3 a )$$

$$0.3 < DLFw / TLw < 0.65 \qquad ( 4 a )$$

$$0.04 < Skw / TLw < 0.15 \qquad ( 5 a )$$

$$- 0.4 < fLN / fLF < - 0.17 \qquad ( 6 a )$$

$$0.04 < \vert fLN / fLR \vert < 0.3 \qquad ( 7 a )$$

$$0.7 < \vert fLR / fLIS \vert < 8. \qquad ( 8 a )$$

$$1.42 < ndF < 1.8 \qquad ( 9 a )$$

$$23 < ν dGIS < 75 \qquad ( 10 a )$$

$$25 < ν GNP < 45 \qquad ( 11 a )$$

$$0.1 < ( R 1 + R 2 ) / ( R 1 - R 2 ) < 10. \qquad ( 12 a )$$

$$- 1.3 < Ymax\_w / fLN < - 0.5 \qquad ( 13 a )$$

$$- 30 < Dist\_w < - 3 \qquad ( 14 a )$$

$$0.25 < Φ IS / Φ R < 0.7 \qquad ( 15 a )$$

Inequalities (3) to (15) may be replaced with inequalities (3b) to (15b) below:

$$33 < ν dF < 80 \qquad ( 3 b )$$

$$0.4 < DLFw / TLw < 0.62 \qquad ( 4 b )$$

$$0.05 < Skw / TLw < 0.1 \qquad ( 5 b )$$

$$- 0.38 < fLN / fLF < - 0.18 \qquad ( 6 b )$$

$$0.07 < \vert fLN / fLR \vert < 0.25 \qquad ( 7 b )$$

$$0.8 < \vert fLR / fLIS \vert < 6. \qquad ( 8 b )$$

$$1.43 < ndF < 1.7 \qquad ( 9 b )$$

$$25 < ν dGIS < 65 \qquad ( 10 b )$$

$$29 < ν GNP < 41 \qquad ( 11 b )$$

$$0.13 < ( R 1 + R 2 ) / ( R 1 - R 2 ) < 7. \qquad ( 12 b )$$

$$- 1.1 < Ymax\_w / fLN < - 0.6 \qquad ( 13 b )$$

$$- 25 < Dist\_w < - 5 \qquad ( 14 b )$$

$$0.4 < Φ IS / Φ R < 0.5 \qquad ( 15 b )$$

The zoom lens L0 according to each example may have a configuration that satisfies inequalities (1), (12), and (15) instead of the configuration that satisfies inequalities (1) and (2). This configuration can realize a zoom lens that is small and has good optical characteristics even during image stabilization.

The zoom lens L0 according to each example will be described in detail.

The zoom lenses L0 according to Examples 1, 4, 5, 6, 9, 10, and 11 include a plurality of lens units that consist of, in order from the object side to the image side, a first lens unit L1 to a sixth lens unit L6 having negative, positive, positive, negative, negative, and positive refractive powers. During zooming from the wide-angle end to the telephoto end, the first lens unit L1 moves along a locus that is convex toward the image side, the second lens unit L2 to the fifth lens unit L5 move toward the object side, and the sixth lens unit L6 is fixed relative to the image plane IP.

The zoom lenses L0 according to Examples 2, 3, 7, and 8 includes a plurality of lens units that consist of, in order from the object side to the image side, a first lens unit L1 to a seventh lens unit L7 having positive, negative, positive, positive, negative, negative, and positive refractive powers. During zooming from the wide-angle end to the telephoto end, the first lens unit L1 is fixed relative to the image plane IP or moves toward the object side, and the second lens unit L2 moves along a locus that is convex toward the image side. The third lens unit L3 to the sixth lens unit L6 move toward the object side, and the seventh lens unit L7 is fixed relative to the image plane IP.

Next follows numerical examples 1 to 11 corresponding to Examples 1 to 11.

In the surface data of each numerical example, r represents a radius of curvature of each optical surface, and d (mm) represents an on-axis distance (distance on the optical axis) between m-th and (m+1)-th surfaces, where m is the number of the surface counted from the light incident side. nd represents a refractive index of each optical element for the d-line, and νd represents an Abbe number of the optical element. The Abbe number νd is expressed as follows:

$$ν d = ( Nd - 1 ) / ( NF - NC )$$

where Nd, NF, and NC are refractive indices for the d-line (587.6 nm), the F line (486.1 nm), and the C line (656.3 nm) in the Fraunhofer line.

In each numerical example, d, a focal length (mm), an F-number (Fno), and a half angle of view (°) are values when the zoom lens L0 is in the in-focus state at infinity. BF represents a back focus expressed by an air conversion length of a distance on the optical axis from a final lens surface that is the lens surface closest to the image plane in the zoom lens to a paraxial image plane. The overall lens length is a sum of the back focus and the distance on the optical axis from the foremost lens surface as a lens surface closest to the object in the zoom lens L0 to the final lens surface.

An asterisk * is added to the right side of the surface number of an optical surface having an aspherical surface shape. An aspherical surface shape is expressed as follows:

$$X = \frac{( 1 / R ) {H}^{2}}{1 + \sqrt{1 - ( 1 + K ) {( H / R )}^{2}}} + A 3 \times {\vert H \vert}^{3} + A 4 \times {\vert H \vert}^{4} + A 5 \times {\vert H \vert}^{5} + A 6 \times {\vert H \vert}^{6} + A 7 \times {\vert H \vert}^{7} + A 8 \times {\vert H \vert}^{8} + A 9 \times {\vert H \vert}^{9} + A 10 \times {\vert H \vert}^{10} + A 11 \times {\vert H \vert}^{11} + A 12 \times {\vert H \vert}^{12} + A 13 \times {\vert H \vert}^{13} + A 14 \times {\vert H \vert}^{14}$$

where X is a displacement amount from a surface vertex in the optical axis direction, h is a height from the optical axis in the direction orthogonal to the optical axis, R is a paraxial radius of curvature, K is a conic constant, and A3 to A14 are aspherical surface coefficients of respective orders. In each aspherical surface coefficient, “e±XX” means “×10^{±XX}” WIDE represents the wide-angle end, MIDDLE represents an intermediate (middle) zoom position, TELE represents a telephoto end.

### Numerical Example 1

UNIT: mm
SURFACE DATA

| Surface No. | r | d | nd | νd |
|---|---|---|---|---|
| 1* | 86.222 | 3.00 | 1.58313 | |
| 2* | 23.969 | 8.06 | | |
| 3 | 29.956 | 2.00 | 2.00100 | 29.1 |
| 4 | 18.232 | 10.71 | | |
| 5 | −214.777 | 1.21 | 1.95375 | 32.3 |
| 6 | 23.515 | 6.53 | | |
| 7 | −79.137 | 1.15 | 1.43875 | 94.7 |
| 8 | 29.973 | 5.81 | 1.95375 | 32.3 |
| 9 | −85.637 | (Variable) | | |
| 10 (SP) | ∞ | (Variable) | | |
| 11 | 47.516 | 1.99 | 1.61340 | 44.3 |
| 12 | −117.604 | (Variable) | | |
| 13 | 32.685 | 1.88 | 1.84666 | 23.8 |
| 14 | 120.703 | 0.99 | | |
| 15 | −38.923 | 0.59 | 1.83481 | 42.7 |
| 16 | 11.454 | 3.56 | 1.65412 | 39.7 |
| 17 | 41.715 | 0.05 | | |
| 18* | 13.250 | 5.08 | 1.49700 | 81.5 |
| 19* | −30.233 | 0.19 | | |
| 20 | 19.675 | 1.00 | 1.83400 | 37.2 |
| 21 | 8.940 | 8.60 | 1.43875 | 94.7 |
| 22 | −23.306 | (Variable) | | |
| 23 | 22.370 | 1.50 | 2.00100 | 29.1 |
| 24 | 15.967 | (Variable) | | |
| 25* | −10.577 | 1.50 | 1.85400 | 40.4 |
| 26* | −17.809 | 0.60 | | |
| 27 | 63.779 | 4.08 | 1.49700 | 81.5 |
| 28 | −87.785 | (Variable) | | |
| 29 | −179.777 | 4.71 | 1.85150 | 40.8 |
| 30 | −53.198 | (Variable) | | |
| Image Plane | ∞ | | | |

ASPHERIC DATA
1st Surface
K = 0.00000e+00 A 4 = 5.88866e−05 A 6 = 2.71045e−07
A 8 = 5.36741e−11 A 3 = 3.29311e−04 A 5 = −6.15243e−06
A 7 = −5.92010e−09
2nd Surface
K = −7.90075e+00 A 4 = 1.47694e−04 A 6 = 1.35724e−07
A 8 = −2.99461e−10 A 3 = 3.43324e−04 A 5 = −9.17894e−06
A 7 = 8.82956e−09
18th Surface
K = 0.00000e+00 A 4 = −2.46414e−05 A 6 = −1.23114e−07
A 8 = −1.25011e−09 A10 = −1.98465e−11
19th Surface
K = 0.00000e+00 A 4 = 2.43298e−05 A 6 = −1.19924e−07
A 8 = 5.09909e−10 A10 = −2.41236e−11
25th Surface
K = −4.39082e+00 A 4 = 1.56262e−04 A 6 = −2.01648e−06
A 8 = −1.99125e−09 A10 = 1.90142e−10 A12 = −8.56409e−13
26th Surface
K = 0.00000e+00 A 4 = 4.84334e−04 A 6 = −4.86423e−06
A 8 = 3.20914e−08 A10 = −1.03447e−10 A12 = 1.00277e−13
VARIOUS DATA
Zoom Ratio 1.88

| | WIDE | MIDDLE | TELE |
|---|---|---|---|
| Focal Length | 10.30 | 14.97 | 19.40 |
| Fno | 4.10 | 4.10 | 4.10 |
| Half Angle of | 64.51 | 55.30 | 48.10 |
| View (°) | | | |
| Image Height | 18.88 | 20.97 | 21.64 |
| Overall Lens | 125.00 | 119.08 | 119.88 |
| Length | | | |
| BF | 11.66 | 11.66 | 11.66 |
| d 9 | 22.73 | 8.82 | 2.00 |
| d10 | 2.48 | 2.17 | 1.81 |
| d12 | 4.00 | 4.31 | 4.67 |
| d22 | 1.64 | 1.64 | 1.64 |
| d24 | 6.70 | 6.70 | 6.70 |
| d28 | 1.00 | 8.99 | 16.62 |
| d30 | 11.66 | 11.66 | 11.66 |

ZOOM LENS UNIT DATA

| Lens Unit | Starting Surface | Focal Length |
|---|---|---|
| 1 | 1 | −18.85 |
| 2 | 11 | 55.43 |
| 3 | 13 | 27.59 |
| 4 | 23 | −63.15 |
| 5 | 25 | −67.72 |
| 6 | 29 | 87.24 |

### Numerical Example 2

UNIT: mm
SURFACE DATA

| Surface No. | r | d | nd | νd |
|---|---|---|---|---|
| 1 | 44.216 | 5.04 | 1.83400 | 37.2 |
| 2 | 44.271 | (Variable) | | |
| 3* | ∞ | 3.00 | 1.58313 | 59.4 |
| 4* | 35.516 | 10.02 | | |
| 5 | 43.913 | 2.00 | 2.00069 | 25.5 |
| 6 | 17.581 | 11.60 | | |
| 7 | −65.202 | 1.17 | 1.59522 | 67.7 |
| 8 | 22.525 | 4.90 | | |
| 9 | −219.980 | 1.00 | 1.43875 | 94.7 |
| 10 | 25.101 | 6.04 | 1.90043 | 37.4 |
| 11 | −121.969 | (Variable) | | |
| 12 (SP) | ∞ | (Variable) | | |
| 13 | 42.796 | 2.21 | 1.53172 | 48.8 |
| 14 | −65.238 | (Variable) | | |
| 15 | 31.908 | 1.82 | 1.84666 | 23.8 |
| 16 | 116.987 | 0.98 | | |
| 17 | −36.788 | 0.53 | 1.83481 | 42.7 |
| 18 | 11.519 | 3.33 | 1.65412 | 39.7 |
| 19 | 40.433 | 0.06 | | |
| 20* | 13.166 | 4.95 | 1.49700 | 81.5 |
| 21* | −26.670 | 0.20 | | |
| 22 | 21.533 | 1.00 | 1.83400 | 37.2 |
| 23 | 9.054 | 8.95 | 1.43875 | 94.7 |
| 24 | −21.868 | (Variable) | | |
| 25 | 24.213 | 1.47 | 1.95375 | 32.3 |
| 26 | 16.411 | (Variable) | | |
| 27* | −10.820 | 1.52 | 1.85400 | 40.4 |
| 28* | −18.018 | 0.20 | | |
| 29 | 61.986 | 3.93 | 1.49700 | 81.5 |
| 30 | −94.540 | (Variable) | | |
| 31 | −158.434 | 4.95 | 1.88300 | 40.8 |
| 32 | −48.699 | (Variable) | | |
| Image Plane | ∞ | | | |

ASPHERIC DATA
3rd Surface
K = 0.00000e+00 A 4 = 4.03980e−05 A 6 = 3.05256e−07
A 8 = 6.14536e−11 A 3 = 7.51249e−04 A 5 = −6.30262e−06
A 7 = −6.82962e−09
4th Surface
K = −2.11592e+01 A 4 = 1.30780e−04 A 6 = 4.02969e−07
A 8 = −1.07622e−10 A 3 = 7.49110e−04 A 5 = −1.21007e−05
A 7 = −1.83058e−09
20th Surface
K = 0.00000e+00 A 4 = −3.02138e−05 A 6 = −8.46711e−08
A 8 = −2.39508e−09 A10 = −1.12787e−11
21st Surface
K = 0.00000e+00 A 4 = 3.00266e−05 A 6 = −8.52472e−08
A 8 = −5.08535e−10 A10 = −1.60003e−11
27th Surface
K = −4.46882e+00 A 4 = 1.77157e−04 A 6 = −2.23587e−06
A 8 = 2.75520e−09 A10 = 1.21058e−10 A12 = −5.63989e−13
28th Surface
K = 0.00000e+00 A 4 = 4.82111e−04 A 6 = −4.73255e−06
A 8 = 3.01815e−08 A10 = −9.59575e−11 A12 = 9.33610e−14
VARIOUS DATA
Zoom Ratio 1.88

| | WIDE | MIDDLE | TELE |
|---|---|---|---|
| Focal Length | 10.30 | 15.01 | 19.40 |
| Fno | 4.10 | 4.10 | 4.10 |
| Half Angle of | 64.53 | 55.40 | 48.20 |
| View (°) | | | |
| Image Height | 18.56 | 20.89 | 21.64 |
| Overall Lens | 130.00 | 130.00 | 130.00 |
| Length | | | |
| BF | 11.81 | 11.81 | 11.81 |
| d 2 | 1.30 | 6.25 | 5.18 |
| d11 | 21.50 | 8.56 | 2.00 |
| d12 | 2.22 | 1.91 | 1.75 |
| d14 | 3.58 | 3.88 | 4.04 |
| d24 | 1.50 | 1.50 | 1.50 |
| d26 | 6.23 | 6.23 | 6.23 |
| d30 | 1.00 | 8.99 | 16.62 |
| d32 | 11.81 | 11.81 | 11.81 |

ZOOM LENS UNIT DATA

| Lens Unit | Starting Surface | Focal Length |
|---|---|---|
| 1 | 1 | 1000.00 |
| 2 | 3 | −17.03 |
| 3 | 13 | 48.95 |
| 4 | 15 | 28.09 |
| 5 | 25 | −58.82 |
| 6 | 27 | −71.59 |
| 7 | 31 | 77.98 |

### Numerical Example 3

UNIT: mm
SURFACE DATA

| Surface No. | r | d | nd | νd |
|---|---|---|---|---|
| 1 | 78.166 | 7.36 | 1.84666 | 23.8 |
| 2 | 80.367 | (Variable) | | |
| 3* | −49008.804 | 3.00 | 1.58313 | 59.4 |
| 4* | 28.841 | 16.03 | | |
| 5 | 56.482 | 2.00 | 2.00100 | 29.1 |
| 6 | 19.363 | 12.83 | | |
| 7 | −65.413 | 1.20 | 1.49700 | 81.5 |
| 8 | 23.436 | 5.59 | | |
| 9 | −180.473 | 1.07 | 1.43875 | 94.7 |
| 10 | 26.575 | 6.26 | 1.87070 | 40.7 |
| 11 | −134.570 | (Variable) | | |
| 12 (SP) | ∞ | (Variable) | | |
| 13 | 53.620 | 2.20 | 1.64769 | 33.8 |
| 14 | −369.172 | (Variable) | | |
| 15 | 23.578 | 2.80 | 1.58144 | 40.8 |
| 16 | −90.857 | 0.84 | | |
| 17 | −36.824 | 0.98 | 1.88300 | 40.8 |
| 18 | 10.611 | 3.43 | 1.68893 | 31.1 |
| 19 | 44.758 | 0.03 | | |
| 20* | 12.557 | 4.35 | 1.49700 | 81.5 |
| 21* | −31.708 | 0.19 | | |
| 22 | 27.184 | 1.00 | 1.83400 | 37.2 |
| 23 | 9.057 | 7.44 | 1.43875 | 94.7 |
| 24 | −20.000 | (Variable) | | |
| 25 | 22.037 | 3.16 | 2.00069 | 25.5 |
| 26 | 16.078 | (Variable) | | |
| 27* | −12.793 | 1.52 | 1.85400 | 40.4 |
| 28* | −21.402 | 0.20 | | |
| 29 | 87.036 | 2.53 | 1.49700 | 81.5 |
| 30 | −254.550 | (Variable) | | |
| 31 | −330.894 | 5.36 | 1.88300 | 40.8 |
| 32 | −51.223 | (Variable) | | |
| Image Plane | ∞ | | | |

ASPHERIC DATA
3rd Surface
K = 0.00000e+00 A 4 = −1.02650e−04 A 6 = 8.35995e−08
A 8 = 6.87583e−11 A10 = 2.75578e−15
A 3 = 1.91154e−03 A 5 = 1.17363e−06 A 7 = −3.74687e−09
A 9 = −6.41953e−13
4th Surface
K = −1.49690e+01 A 4 = 2.44257e−05 A 6 = 5.49826e−07
A 8 = 1.82659e−11 A10 = −2.43061e−13
A 3 = 1.95219e−03 A 5 = −9.70026e−06 A 7 = −1.44893e−08
A 9 = 1.16941e−11
20th Surface
K = 0.00000e+00 A 4 = −2.42746e−05 A 6 = −8.32737e−08
A 8 = −4.53990e−09 A10 = 9.39569e−12
21st Surface
K = 0.00000e+00 A 4 = 3.10508e−05 A 6 = −1.95743e−07
A 8 = −1.48621e−09 A10 = −1.04503e−12
27th Surface
K = −5.72248e+00 A 4 = 2.17787e−04 A 6 = −3.06705e−06
A 8 = 1.41009e−08 A10 = 4.27188e−11 A12 = −5.61382e−13
28th Surface
K = 0.00000e+00 A 4 = 4.67134e−04 A 6 = −4.87535e−06
A 8 = 3.21693e−08 A10 = −1.14152e−10 A12 = 1.18708e−13
VARIOUS DATA
Zoom Ratio 2.07

| | WIDE | MIDDLE | TELE |
|---|---|---|---|
| Focal Length | 7.50 | 11.64 | 15.54 |
| Fno | 4.10 | 4.10 | 4.10 |
| Half Angle of | 70.88 | 63.70 | 54.30 |
| View (°) | | | |
| Image Height | 16.90 | 21.62 | 21.64 |
| Overall Lens | 144.42 | 144.42 | 144.42 |
| Length | | | |
| BF | 11.00 | 11.00 | 11.00 |
| d 2 | 1.43 | 11.32 | 12.04 |
| d11 | 28.21 | 10.34 | 1.99 |
| d12 | 2.00 | 1.91 | 1.91 |
| d14 | 2.68 | 2.77 | 2.77 |
| d24 | 1.50 | 1.50 | 1.50 |
| d26 | 5.22 | 5.22 | 5.22 |
| d30 | 1.00 | 8.99 | 16.61 |
| d32 | 11.00 | 11.00 | 11.00 |

ZOOM LENS UNIT DATA

| Lens Unit | Starting Surface | Focal Length |
|---|---|---|
| 1 | 1 | 1330.27 |
| 2 | 3 | −15.45 |
| 3 | 13 | 72.43 |
| 4 | 15 | 28.44 |
| 5 | 25 | −80.82 |
| 6 | 27 | −60.65 |
| 7 | 31 | 68.02 |

### Numerical Example 4

UNIT: mm
SURFACE DATA

| Surface No. | r | d | nd | νd |
|---|---|---|---|---|
| 1* | 87.938 | 3.00 | 1.58313 | 59.4 |
| 2* | 24.978 | 9.12 | | |
| 3 | 37.971 | 2.00 | 2.00069 | 25.5 |
| 4 | 18.595 | 9.69 | | |
| 5 | 435.012 | 1.44 | 1.49700 | 81.5 |
| 6 | 31.807 | 6.19 | | |
| 7 | −48.211 | 1.19 | 1.43875 | 94.7 |
| 8 | 30.532 | 6.74 | 1.83400 | 37.2 |
| 9 | −99.592 | (Variable) | | |
| 10 (SP) | ∞ | (Variable) | | |
| 11 | 108.131 | 2.38 | 1.48749 | 70.2 |
| 12 | −94.759 | (Variable) | | |
| 13 | 19.503 | 7.71 | 1.65412 | 39.7 |
| 14 | −53.578 | 0.76 | | |
| 15 | −39.697 | 0.73 | 1.83481 | 42.7 |
| 16 | 11.606 | 4.86 | 1.48749 | 70.2 |
| 17 | 49.774 | 0.51 | | |
| 18* | 19.321 | 7.48 | 1.49700 | 81.5 |
| 19* | −25.101 | 0.20 | | |
| 20 | 42.288 | 1.00 | 1.85150 | 40.8 |
| 21 | 12.798 | 10.69 | 1.43875 | 94.7 |
| 22 | −32.600 | 0.20 | | |
| 23 | −37.287 | 3.00 | 1.51742 | 52.4 |
| 24 | −39.699 | (Variable) | | |
| 25 | −50.000 | 1.19 | 1.75500 | 52.3 |
| 26 | 37.077 | (Variable) | | |
| 27* | 38.775 | 2.69 | 1.85400 | 40.4 |
| 28 | 72.057 | (Variable) | | |
| 29 | 111.642 | 3.89 | 1.85150 | 40.8 |
| 30 | ∞ | (Variable) | | |
| Image Plane | ∞ | | | |

ASPHERIC DATA
1st Surface
K = 0.00000e+00 A 4 = 1.16078e−04 A 6 = 4.83849e−07
A 8 = 1.40833e−10 A10 = −1.01365e−14
A 3 = −1.94654e−04 A 5 = −1.05036e−05 A 7 = −1.21754e−08
A 9 = −7.64059e−15
2nd Surface
K = −8.70096e+00 A 4 = 2.09252e−04 A 6 = 4.00227e−08
A 8 = −2.52927e−09 A10 = −9.52889e−13
A 3 = −2.32064e−04 A 5 = −1.27262e−05 A 7 = 3.99123e−08
A 9 = 7.45610e−11
18th Surface
K = 0.00000e+00 A 4 = −2.37144e−05 A 6 = −1.51179e−10
A 8 = −8.17971e−10 A10 = 8.77567e−13
19th Surface
K = 0.00000e+00 A 4 = −4.87659e−06 A 6 = −7.50934e−08
A 8 = −1.05956e−09 A10 = 3.43508e−13
27th Surface
K = 0.00000e+00 A 4 = −4.87630e−06 A 6 = 1.11639e−08
A 8 = −5.08481e−12 A10 = 5.48139e−14 A12 = −1.09259e−16
VARIOUS DATA
Zoom Ratio 1.90

| | WIDE | MIDDLE | TELE |
|---|---|---|---|
| Focal Length | 12.98 | 18.93 | 24.66 |
| Fno | 4.10 | 4.10 | 4.10 |
| Half Angle of | 59.03 | 48.30 | 40.80 |
| View (°) | | | |
| Image Height | 18.80 | 20.73 | 21.64 |
| Overall Lens | 140.00 | 133.03 | 132.48 |
| Length | | | |
| BF | 8.00 | 8.00 | 8.00 |
| d 9 | 27.04 | 12.08 | 3.90 |
| d10 | 2.85 | 1.94 | 2.20 |
| d12 | 4.71 | 5.62 | 5.36 |
| d24 | 8.12 | 8.12 | 8.12 |
| d26 | 1.63 | 1.63 | 1.63 |
| d28 | 1.00 | 8.99 | 16.61 |
| d30 | 8.00 | 8.00 | 8.00 |

ZOOM LENS UNIT DATA

| Lens Unit | Starting Surface | Focal Length |
|---|---|---|
| 1 | 1 | −23.90 |
| 2 | 11 | 104.00 |
| 3 | 13 | 35.84 |
| 4 | 25 | −28.03 |
| 5 | 27 | 94.78 |
| 6 | 29 | 131.11 |

### Numerical Example 5

UNIT: mm
SURFACE DATA

| Surface No. | r | d | nd | vd |
|---|---|---|---|---|
| 1* | 195.603 | 3.00 | 1.58313 | 59.4 |
| 2* | 29.771 | 7.19 | | |
| 3 | 30.368 | 2.00 | 2.00100 | 29.1 |
| 4 | 18.360 | 10.53 | | |
| 5 | −391.432 | 1.28 | 1.95375 | 32.3 |
| 6 | 25.535 | 8.26 | | |
| 7 | −75.285 | 1.16 | 1.43875 | 94.7 |
| 8 | 34.222 | 5.29 | 1.95375 | 32.3 |
| 9 | −95.269 | (Variable) | | |
| 10 | 48.933 | 2.03 | 1.61340 | 44.3 |
| 11 | −119.511 | (Variable) | | |
| 12 (SP) | ∞ | 2.00 | | |
| 13 | 30.374 | 1.61 | 1.84666 | 23.8 |
| 14 | 85.250 | 1.12 | | |
| 15 | −38.350 | 0.43 | 1.83481 | 42.7 |
| 16 | 11.968 | 3.26 | 1.65412 | 39.7 |
| 17 | 38.409 | 0.06 | | |
| 18* | 13.000 | 5.09 | 1.49700 | 81.5 |
| 19* | 31.509 | 0.20 | | |
| 20 | 18.533 | 1.00 | 1.83400 | 37.2 |
| 21 | 8.879 | 7.31 | 1.43875 | 94.7 |
| 22 | −25.631 | (Variable) | | |
| 23 | 23.403 | 2.20 | 2.00100 | 29.1 |
| 24 | 16.712 | (Variable) | | |
| 25* | −10.631 | 1.49 | 1.85400 | 40.4 |
| 26* | −18.504 | 0.32 | | |
| 27 | 65.906 | 3.71 | 1.49700 | 81.5 |
| 28 | −106.154 | (Variable) | | |
| 29 | −140.296 | 5.06 | 1.85150 | 40.8 |
| 30 | −47.042 | (Variable) | | |
| Image Plane | ∞ | | | |

ASPHERIC DATA
1 st Surface
K = 0.00000e+00 A 4 = 6.48190e−05 A 6 = 2.71077e−07
A 8 = 5.33858e−11 A 3 = 2.95164e−04 A 5 = −6.25422e−06
A 7 = −5.90585e−09
2nd Surface
K = −1.29758e+01 A 4 = 1.41276e−04 A 6 = 1.50277e−07
A 8 = −2.54472e−10 A 3 = 3.14489e−04 A 5 = −8.98231e−06
A 7 = 7.65960e−09
18th Surface
K = 0.00000e+00 A 4 = −2.99461e−05 A 6 = −1.49065e−07
A 8 = −1.99978e−09 A10 = −3.82462e−12
19th Surface
K = 0.00000e+00 A 4 = 2.17902e−05 A 6 = −9.04078e−08
A 8 = −6.91774e−10 A10 = −1.76583e−12
25th Surface
K = −4.30841e+00 A 4 = 1.49220e−04 A 6 = −2.05193e−06
A 8 = 3.77297e−11 A10 = 1.52479e−10 A12 = −6.80726e−13
26th Surface
K = 0.00000e+00 A 4 = 4.69609e−04 A 6 = −4.67532e−06
A 8 = 3.04560e−08 A10 = −9.98396e−11 A12 = 1.05834e−13
VARIOUS DATA
Zoom Ratio 1.88

| | WIDE | MIDDLE | TELE |
|---|---|---|---|
| Focal Length | 10.79 | 15.67 | 20.29 |
| Fno | 2.99 | 3.56 | 4.10 |
| Half Angle of View (°) | 63.49 | 54.10 | 47.10 |
| Image Height | 18.92 | 20.92 | 21.64 |
| Overall Lens Length | 125.00 | 119.30 | 120.08 |
| BF | 11.29 | 11.29 | 11.29 |
| d 9 | 23.48 | 9.22 | 1.99 |
| d11 | 4.68 | 5.25 | 5.63 |
| d22 | 1.50 | 1.50 | 1.50 |
| d24 | 7.06 | 7.06 | 7.06 |
| d28 | 1.40 | 9.39 | 17.02 |
| d30 | 11.29 | 11.29 | 11.29 |

ZOOM LENS UNIT DATA

| Lens Unit | Starting Surface | Focal Length |
|---|---|---|
| 1 | 1 | −19.79 |
| 2 | 10 | 56.86 |
| 3 | 12 | 28.05 |
| 4 | 23 | −69.90 |
| 5 | 25 | −56.22 |
| 6 | 29 | 81.09 |

### Numerical Example 6

UNIT: mm
SURFACE DATA

| Surface | | | | |
|---|---|---|---|---|
| No. | r | d | nd | vd |
| 1* | ∞ | 3.00 | 1.58313 | 59.4 |
| 2* | 114.973 | 1.49 | | |
| 3 | 42.086 | 2.00 | 1.84666 | 23.8 |
| 4 | 21.076 | 4.11 | | |
| 5 | 26.130 | 1.33 | 1.69680 | 55.5 |
| 6 | 17.306 | 13.56 | | |
| 7 | −42.422 | 1.11 | 1.43875 | 94.7 |
| 8 | 22.912 | 6.55 | 1.67270 | 32.1 |
| 9 | −409.285 | (Variable) | | |
| 10 (SP) | ∞ | (Variable) | | |
| 11 | 1911.251 | 1.81 | 1.77250 | 49.6 |
| 12 | −60.890 | (Variable) | | |
| 13 | 35.375 | 1.84 | 1.84666 | 23.8 |
| 14 | 111.937 | 1.45 | | |
| 15 | −34.747 | 2.00 | 1.65412 | 39.7 |
| 16 | 27.417 | 0.04 | | |
| 17* | 13.792 | 5.79 | 1.49700 | 81.5 |
| 18* | −33.120 | 0.20 | | |
| 19 | 16.330 | 1.84 | 1.91082 | 35.2 |
| 20 | 9.033 | 8.14 | 1.43875 | 94.7 |
| 21 | −29.277 | (Variable) | | |
| 22 | 1000.000 | 1.20 | 1.48749 | 70.2 |
| 23 | 17.299 | (Variable) | | |
| 24* | −18.352 | 1.50 | 1.85400 | 40.4 |
| 25* | −33.298 | 0.20 | | |
| 26 | 41.073 | 3.71 | 1.49700 | 81.5 |
| 27 | 254.496 | (Variable) | | |
| 28 | −79.308 | 5.44 | 1.84666 | 23.8 |
| 29 | −50.685 | (Variable) | | |
| Image | ∞ | | | |
| Plane | | | | |

ASPHERIC DATA
1st Surface
K = 0.00000e+00 A 4 = 9.05036e−05 A 6 = 2.24078e−07
A 8 = 3.02661e−11 A 3 = −7.33736e−05 A 5 = −6.36162e−06
A 7 = −4.05317e−09
2nd Surface
K = −1.38608e+02 A 4 = 1.08786e−04 A 6 = 2.63771e−07
A 8 = 3.37761e−11 A 3 = −6.58470e−05 A 5 = −7.63372e−06
A 7 = −4.78127e−09
17th Surface
K= 0.00000e+00 A 4 = −3.17219e−05 A 6 = −7.93695e−08
A 8 = −9.89563e−10 A10 = −1.43321e−12
18th Surface
K = 0.00000e+00 A 4 = 2.20357e−05 A 6 = 2.30345e−08
A 8 = −2.94143e−10 A10 = −2.49703e−13
24th Surface
K = −1.42058e+00 A 4 = −2.79545e−05 A 6 = −9.12741e−07
A 8 = 2.05992e−08 A10 = −2.14562e−10 A12 = 1.18654e−12
25th Surface
K = 0.00000e+00 A 4 = 1.42592e−05 A 6 = −4.69847e−07
A 8 = 9.10972e−09 A10 = −6.90700e−11 A12 = 2.42484e−13
VARIOUS DATA
Zoom Ratio 1.88

| | WIDE | MIDDLE | TELE |
|---|---|---|---|
| Focal Length | 17.00 | 24.70 | 31.96 |
| Fno | 4.10 | 4.10 | 4.10 |
| Half Angle of View (°) | 51.81 | 41.20 | 34.30 |
| Image Height | 19.42 | 20.96 | 21.64 |
| Overall Lens Length | 120.00 | 114.82 | 116.17 |
| BF | 10.00 | 10.00 | 10.00 |
| d 9 | 21.44 | 8.27 | 2.00 |
| d10 | 3.11 | 2.66 | 1.98 |
| d12 | 5.49 | 5.94 | 6.62 |
| d21 | 1.50 | 1.50 | 1.50 |
| d23 | 7.02 | 7.02 | 7.02 |
| d27 | 3.14 | 11.13 | 18.75 |
| d29 | 10.00 | 10.00 | 10.00 |

ZOOM LENS UNIT DATA

| Lens Unit | Starting Surface | Focal Length |
|---|---|---|
| 1 | 1 | −27.69 |
| 2 | 11 | 76.42 |
| 3 | 13 | 24.45 |
| 4 | 22 | −36.12 |
| 5 | 24 | −106.49 |
| 6 | 28 | 152.58 |

### Numerical Example 7

UNIT: mm
SURFACE DATA

| Surface No. | r | d | nd | vd |
|---|---|---|---|---|
| 1 | 103.139 | 8.03 | 1.52841 | 76.5 |
| 2 | 393.490 | (Variable) | | |
| 3* | 409.087 | 3.00 | 1.58313 | 59.4 |
| 4* | 37.382 | 3.89 | | |
| 5 | 44.858 | 2.00 | 1.84666 | 23.8 |
| 6 | 18.873 | 12.48 | | |
| 7 | −78.890 | 1.43 | 1.43875 | 94.7 |
| 8 | 831.997 | 1.80 | | |
| 9 | −84.231 | 1.10 | 1.43875 | 94.7 |
| 10 | 27.745 | 5.52 | 1.71736 | 29.5 |
| 11 | −211.145 | (Variable) | | |
| 12 (SP) | ∞ | (Variable) | | |
| 13 | 2418.432 | 2.01 | 1.43875 | 94.7 |
| 14 | −45.872 | (Variable) | | |
| 15 | 22.557 | 2.37 | 1.80610 | 33.3 |
| 16 | 96.679 | 1.33 | | |
| 17 | −88.646 | 1.00 | 1.83400 | 37.2 |
| 18 | 12.933 | 3.21 | 1.67270 | 32.1 |
| 19 | 27.938 | −0.05 | | |
| 20* | 14.330 | 5.87 | 1.49700 | 81.5 |
| 21* | −37.217 | 0.19 | | |
| 22 | 19.274 | 0.99 | 1.91082 | 35.2 |
| 23 | 10.112 | 8.42 | 1.43875 | 94.7 |
| 24 | −23.340 | (Variable) | | |
| 25 | 1000.000 | 1.19 | 1.48749 | 70.2 |
| 26 | 15.354 | (Variable) | | |
| 27* | −10.939 | 1.50 | 1.85400 | 40.4 |
| 28* | −17.115 | 0.21 | | |
| 29 | −154.272 | 3.13 | 1.84666 | 23.8 |
| 30 | −51.745 | (Variable) | | |
| 31 | −45.885 | 4.14 | 1.84666 | 23.8 |
| 32 | −40.900 | (Variable) | | |
| Image Plane | ∞ | | | |

ASPHERIC DATA
3rd Surface
K = 0.00000e+00 A 4 = 6.15371e−05 A 6 = 2.11462e−07
A 8 = 3.79971e−11 A 3 = −9.46791e−05 A 5 = −5.22448e−06
A 7 = −4.40585e−09
4th Surface
K = −1.61080e+01 A 4 = 1.10934e−04 A 6 = 1.35443e−07
A 8 = −9.59470e−11 A 3 = −1.07437e−04 A 5 = −6.77180e−06
A 7 = 2.25385e−09
20th Surface
K = 0.00000e+00 A 4 = −2.59288e−05 A 6 = −4.24217e−08
A 8 = −7.32189e−10 A10 = −4.13353e−12
21st Surface
K = 0.00000e+00 A 4 = 2.83758e−05 A 6 = −2.20474e−09
A 8 = −9.52407e−10 A10 = −1.77020e−13
27th Surface
K = −3.24970e+00 A 4 = −5.06970e−05 A 6 = −2.43547e−07
A 8 = −4.57954e−09 A10 = 6.83464e−11 A12 = −3.42121e−13
28th Surface
K = 0.00000e+00 A 4 = 1.84885e−04 A 6 = −1.65459e−06
A 8 = 9.94907e−09 A10 = −3.35369e−11 A12 = 3.71528e−14
VARIOUS DATA
Zoom Ratio 2.10

| | WIDE | MIDDLE | TELE |
|---|---|---|---|
| Focal Length | 22.10 | 33.39 | 46.41 |
| Fno | 4.50 | 5.00 | 5.60 |
| Half Angle of View (°) | 47.00 | 33.00 | 24.60 |
| Image Height | 21.64 | 21.64 | 21.64 |
| Overall Lens Length | 135.00 | 144.57 | 162.51 |
| BF | 11.00 | 11.00 | 11.00 |
| d 2 | 1.11 | 16.69 | 33.96 |
| d11 | 22.96 | 8.97 | 1.99 |
| d12 | 1.99 | 2.59 | 1.98 |
| d14 | 8.66 | 8.06 | 8.67 |
| d24 | 1.49 | 1.53 | 1.58 |
| d26 | 11.38 | 11.34 | 11.29 |
| d30 | 1.64 | 9.63 | 17.26 |
| d32 | 11.00 | 11.00 | 11.00 |

ZOOM LENS UNIT DATA

| Lens Unit | Starting Surface | Focal Length |
|---|---|---|
| 1 | 1 | 262.02 |
| 2 | 3 | −28.05 |
| 3 | 13 | 102.63 |
| 4 | 15 | 23.96 |
| 5 | 25 | −32.00 |
| 6 | 27 | −79.69 |
| 7 | 31 | 322.00 |

### Numerical Example 8

UNIT: mm
SURFACE DATA

| | | | | |
|---|---|---|---|---|
| Surface | | | | |
| No. | r | d | nd | vd |
| 1 | 102.925 | 8.25 | 1.52841 | 76.5 |
| 2 | 399.398 | (Variable) | | |
| 3* | 285.853 | 3.00 | 1.58313 | 59.4 |
| 4* | 36.533 | 5.81 | | |
| 5 | 63.053 | 2.00 | 1.83481 | 42.7 |
| 6 | 19.815 | 18.75 | | |
| 7 | −49.010 | 1.38 | 1.43875 | 94.7 |
| 8 | 422.384 | 1.62 | | |
| 9 | −239.258 | 1.08 | 1.43875 | 94.7 |
| 10 | 35.934 | 4.55 | 1.72342 | 38.0 |
| 11 | −145.642 | (Variable) | | |
| 12 (SP) | ∞ | (Variable) | | |
| 13 | 174.826 | 1.84 | 1.43875 | 94.7 |
| 14 | −87.428 | (Variable) | | |
| 15 | 19.850 | 2.59 | 1.64769 | 33.8 |
| 16 | 126.568 | 1.26 | | |
| 17 | −120.155 | 1.00 | 1.83481 | 42.7 |
| 18 | 12.899 | 2.65 | 1.67003 | 47.2 |
| 19 | 24.459 | 0.16 | | |
| 20* | 14.169 | 5.23 | 1.49700 | 81.5 |
| 21* | −36.411 | 0.20 | | |
| 22 | 19.817 | 1.00 | 1.88300 | 40.8 |
| 23 | 10.209 | 10.08 | 1.43875 | 94.7 |
| 24 | −23.093 | (Variable) | | |
| 25 | 285.800 | 1.20 | 1.51823 | 58.9 |
| 26 | 16.410 | (Variable) | | |
| 27* | −11.210 | 1.50 | 1.85400 | 40.4 |
| 28* | −17.860 | 0.20 | | |
| 29 | −75.147 | 3.02 | 1.80518 | 25.4 |
| 30 | −39.745 | (Variable) | | |
| 31 | −53.642 | 3.49 | 1.76182 | 26.5 |
| 32 | −38.757 | (Variable) | | |
| Image | ∞ | | | |
| Plane | | | | |

ASPHERIC DATA
3rd Surface
K = 0.00000e+00 A 4 = 6.66930e−05 A 6 = 2.07180e−07
A 8 = 3.31843e−11 A 3 = −1.20493e−04 A 5 = −5.33962e−06
A 7 = −4.12320e−09
4th Surface
K = −1.51284e+01 A 4 = 1.16073e−04 A 6 = 1.53498e−07
A 8 = −9.66997e−11 A 3 = −1.35690e−04 A 5 = −7.10422e−06
A 7 = 1.69256e−09
20th Surface
K = 0.00000e+00 A 4 = −3.15143e−05 A 6 = −2.83540e−08
A 8 = −1.00512e−09 A10 = −1.54005e−12
21st Surface
K = 0.00000e+00 A 4 = 2.72695e−05 A 6 = 1.14146e−08
A 8 = −8.74300e−10 A10 = 3.06798e−13
27th Surface
K = −3.25702e+00 A 4 = −6.32744e−05 A 6 = −1.23651e−07
A 8 = −4.79781e−09
A10 = 6.26468e−11 A12 = −2.73811e−13
28th Surface
K = 0.00000e+00 A 4 = 1.64236e−04 A 6 = −1.42821e−06
A 8 = 8.41643e−09 A10 = −2.63923e−11 A12 = 2.84784e−14
VARIOUS DATA
Zoom Ratio

| | WIDE | MIDDLE | TELE |
|---|---|---|---|
| Focal Length | 19.03 | 28.24 | 38.06 |
| Fno | 4.50 | 5.00 | 5.60 |
| Half Angle of View (°) | 50.12 | 37.20 | 29.10 |
| Image Height | 21.64 | 21.64 | 21.64 |
| Overall Lens Length | 140.00 | 148.39 | 162.22 |
| BF | 11.00 | 11.00 | 11.00 |
| d 2 | 0.81 | 14.61 | 27.47 |
| d11 | 22.05 | 8.64 | 2.00 |
| d12 | 1.87 | 2.54 | 1.99 |
| d14 | 7.13 | 6.47 | 7.02 |
| d24 | 1.63 | 1.63 | 1.63 |
| d26 | 12.11 | 12.11 | 12.11 |
| d30 | 1.55 | 9.54 | 17.17 |
| d32 | 11.00 | 11.00 | 11.00 |

ZOOM LENS UNIT DATA

| Lens Unit | Starting Surface | Focal Length |
|---|---|---|
| 1 | 1 | 259.90 |
| 2 | 3 | −25.10 |
| 3 | 13 | 133.12 |
| 4 | 15 | 24.14 |
| 5 | 25 | −33.64 |
| 6 | 27 | −71.44 |
| 7 | 31 | 166.45 |

### Numerical Example 9

UNIT: mm
SURFACE DATA

| Surface No. | r | d | nd | vd |
|---|---|---|---|---|
| 1* | 100.388 | 3.00 | 1.58313 | 59.4 |
| 2* | 22.974 | 8.78 | | |
| 3 | 34.455 | 2.00 | 2.00069 | 25.5 |
| 4 | 18.887 | 10.05 | | |
| 5 | 374.251 | 1.41 | 1.49700 | 81.5 |
| 6 | 27.831 | 6.60 | | |
| 7 | −53.116 | 1.82 | 1.43875 | 94.7 |
| 8 | 30.320 | 6.42 | 1.83400 | 37.2 |
| 9 | −111.103 | (Variable) | | |
| 10 (SP) | ∞ | (Variable) | | |
| 11 | 81.313 | 1.73 | 1.48749 | 70.2 |
| 12 | −169.996 | (Variable) | | |
| 13 | 19.219 | 7.99 | 1.65412 | 39.7 |
| 14 | −48.223 | 0.72 | | |
| 15 | −35.690 | 0.65 | 1.83481 | 42.7 |
| 16 | 11.271 | 4.58 | 1.48749 | 70.2 |
| 17 | 50.604 | 0.38 | | |
| 18* | 19.639 | 6.84 | 1.49700 | 81.5 |
| 19* | −23.455 | 0.20 | | |
| 20 | 40.847 | 1.00 | 1.83481 | 42.7 |
| 21 | 12.812 | 10.15 | 1.43875 | 94.7 |
| 22 | −23.193 | 1.85 | | |
| 23 | −24.753 | 1.21 | 1.51823 | 58.9 |
| 24 | −48.466 | (Variable) | | |
| 25 | 10000.000 | 1.83 | 1.83481 | 42.7 |
| 26 | 31.052 | (Variable) | | |
| 27* | 47.544 | 3.23 | 1.85400 | 40.4 |
| 28 | 75.663 | (Variable) | | |
| 29 | 108.548 | 4.07 | 1.84666 | 23.8 |
| 30 | −43396.938 | (Variable) | | |
| Image Plane | ∞ | | | |

ASPHERIC DATA
1st Surface
K = 0.00000e+00 A 4 = 1.04037e−04 A 6 = 4.53693e−07
A 8 = 1.73655e−10 A10 = −1.82973e−15
A 3 = −1.76041e−04 A 5 = −9.58598e−06 A 7 = −1.21927e−08
A 9 = −9.29130e−13
2nd Surface
K = −7.42537e+00 A 4 = 1.99199e−04 A 6 = −7.72051e−08
A 8 = −2.92873e−09 A10 = −1.05207e−12
A 3 = −2.12818e−04 A 5 = −1.14116e−05 A 7 = 4.81065e−08
A 9 = 8.49751e−11
18th Surface
K = 0.00000e+00 A 4 = −2.48033e−05 A 6 = 1.63104e−08
A 8 = −1.18081e−09 A10 = 2.26132e−12
19th Surface
K = 0.00000e+00 A 4 = −2.67473e−06 A 6 = −9.28252e−08
A 8 = −1.43016e−09 A10 = −8.06934e−13
27th Surface
K = 0.00000e+00 A 4 = −1.94794e−06 A 6 = 1.04998e−08
A 8 = −9.05022e−13 A10 = 4.37312e−14 A12 = −5.09818e−17
VARIOUS DATA
Zoom Ratio 1.90

| | WIDE | MIDDLE | TELE |
|---|---|---|---|
| Focal Length | 12.14 | 17.70 | 23.06 |
| Fno | 4.10 | 4.10 | 4.10 |
| Half Angle of View (°) | 60.70 | 50.00 | 42.60 |
| Image Height | 18.80 | 20.73 | 21.64 |
| Overall Lens Length | 140.00 | 132.15 | 131.09 |
| BF | 8.00 | 8.00 | 8.00 |
| d 9 | 27.91 | 12.07 | 3.38 |
| d10 | 2.95 | 1.96 | 2.30 |
| d12 | 4.59 | 5.57 | 5.24 |
| d24 | 5.58 | 5.58 | 5.58 |
| d26 | 3.48 | 3.48 | 3.48 |
| d28 | 1.00 | 8.99 | 16.62 |
| d30 | 8.00 | 8.00 | 8.00 |

ZOOM LENS UNIT DATA

| Lens Unit | Starting Surface | Focal Length |
|---|---|---|
| 1 | 1 | −23.05 |
| 2 | 11 | 113.08 |
| 3 | 13 | 35.58 |
| 4 | 25 | −37.32 |
| 5 | 27 | 142.27 |
| 6 | 29 | 127.89 |

### Numerical Example 10

UNIT: mm
SURFACE DATA

| Surface No. | r | d | nd | vd |
|---|---|---|---|---|
| 1* | 143.743 | 3.00 | 1.58313 | 59.4 |
| 2* | 26.890 | 7.86 | | |
| 3 | 29.889 | 2.00 | 2.00100 | 29.1 |
| 4 | 17.859 | 10.33 | | |
| 5 | −306.735 | 1.28 | 1.95375 | 32.3 |
| 6 | 23.105 | 6.52 | | |
| 7 | −69.940 | 1.14 | 1.43875 | 94.7 |
| 8 | 29.605 | 5.92 | 1.95375 | 32.3 |
| 9 | −84.228 | (Variable) | | |
| 10 (SP) | ∞ (Variable) | | | |
| 11 | 45.851 | 2.23 | 1.61340 | 44.3 |
| 12 | −92.854 | (Variable) | | |
| 13 | 33.737 | 1.91 | 1.84666 | 23.8 |
| 14 | 101.745 | 1.19 | | |
| 15 | −38.466 | 0.67 | 1.83481 | 42.7 |
| 16 | 11.078 | 3.65 | 1.65412 | 39.7 |
| 17 | 41.834 | 0.04 | | |
| 18* | 13.142 | 5.22 | 1.49700 | 81.5 |
| 19* | −29.257 | 0.20 | | |
| 20 | 19.983 | 1.00 | 1.83400 | 37.2 |
| 21 | 8.931 | 8.88 | 1.43875 | 94.7 |
| 22 | −22.081 | (Variable) | | |
| 23 | 23.510 | 1.38 | 1.84666 | 23.8 |
| 24 | 29.731 | 1.00 | 2.00100 | 29.1 |
| 25 | 16.321 | (Variable) | | |
| 26* | −10.355 | 1.50 | 1.85400 | 40.4 |
| 27* | −17.798 | 0.20 | | |
| 28 | 60.768 | 4.43 | 1.49700 | 81.5 |
| 29 | −69.930 | (Variable) | | |
| 30 | −142.602 | 4.83 | 1.85150 | 40.8 |
| 31 | −48.334 | (Variable) | | |
| Image Plane | ∞ | | | |

ASPHERIC DATA
1st Surface
K = 0.00000e+00 A 4 = 6.02379e−05 A 6 = 2.91635e−07
A 8 = 5.75729e−11 A 3 = 4.54478e−04 A 5 = −6.58136e−06
A 7 = −6.36493e−09
2nd Surface
K = −1.06443e+01 A 4 = 1.49286e−04 A 6 = 1.87563e−07
A 8 = −2.87567e−10 A 3 = 4.74317e−04 A 5 = −1.00465e−05
A 7 = 7.69161e−09
18th Surface
K = 0.00000e+00 A 4 = −2.65259e−05 A 6 = −1.35816e−07
A 8 = −1.84852e−09 A10 = −1.45376e−11
19th Surface
K = 0.00000e+00 A 4 = 2.45204e−05 A 6 = −1.27786e−07
A 8 = −4.26015e−10 A10 = −1.49755e−11
26th Surface
K = −4.26836e+00 A 4 = 1.57602e−04 A 6 = −1.99039e−06
A 8 = −2.83240e−09 A10 = 2.01532e−10 A12 = −8.43030e−13
27th Surface
K = 0.00000e+00 A 4 = 4.93837e−04 A 6 = −4.95890e−06
A 8 = 3.27202e−08 A10 = −1.03959e−10 A12 = 9.79755e−14
VARIOUS DATA
Zoom Ratio 1.88

| | WIDE | MIDDLE | TELE |
|---|---|---|---|
| Focal Length | 10.30 | 14.96 | 19.40 |
| Fno | 4.10 | 4.10 | 4.10 |
| Half Angle of View (°) | 64.53 | 55.40 | 48.20 |
| Image Height | 18.88 | 20.97 | 21.64 |
| Overall Lens Length | 125.00 | 119.28 | 120.18 |
| BF | 11.08 | 11.08 | 11.08 |
| d 9 | 22.54 | 8.83 | 2.10 |
| d10 | 2.19 | 2.08 | 1.81 |
| d12 | 3.90 | 4.02 | 4.29 |
| d22 | 1.50 | 1.50 | 1.50 |
| d25 | 6.41 | 6.41 | 6.41 |
| d29 | 1.00 | 8.99 | 16.62 |
| d31 | 11.08 | 11.08 | 11.08 |

ZOOM LENS UNIT DATA

| Lens Unit | Starting Surface | Focal Length |
|---|---|---|
| 1 | 1 | −18.47 |
| 2 | 11 | 50.35 |
| 3 | 13 | 28.32 |
| 4 | 23 | −57.60 |
| 5 | 26 | −69.38 |
| 6 | 30 | 83.89 |

### Numerical Example 11

UNIT: mm
SURFACE DATA

| | | | | |
|---|---|---|---|---|
| Surface | | | | |
| No. | r | d | nd | vd |
| 1* | 110.383 | 3.00 | 1.58313 | 59.4 |
| 2* | 22.696 | 8.43 | | |
| 3 | 33.261 | 2.00 | 2.00069 | 25.5 |
| 4 | 18.828 | 9.75 | | |
| 5 | 198.766 | 1.33 | 1.49700 | 81.5 |
| 6 | 26.610 | 6.84 | | |
| 7 | −51.224 | 1.78 | 1.43875 | 94.7 |
| 8 | 29.892 | 6.49 | 1.83400 | 37.2 |
| 9 | −118.054 | (Variable) | | |
| 10 (SP) | ∞ | (Variable) | | |
| 11 | 81.922 | 1.81 | 1.48749 | 70.2 |
| 12 | −160.052 | (Variable) | | |
| 13 | 19.270 | 7.81 | 1.65412 | 39.7 |
| 14 | −46.783 | 0.74 | | |
| 15 | −35.178 | 1.24 | 1.83481 | 42.7 |
| 16 | 11.275 | 4.44 | 1.48749 | 70.2 |
| 17 | 52.453 | 0.34 | | |
| 18* | 19.715 | 6.34 | 1.49700 | 81.5 |
| 19* | −23.772 | 0.20 | | |
| 20 | 39.884 | 1.00 | 1.83481 | 42.7 |
| 21 | 12.870 | 9.51 | 1.43875 | 94.7 |
| 22 | −23.188 | 1.18 | | |
| 23 | −25.013 | 1.20 | 1.51823 | 58.9 |
| 24 | −43.751 | (Variable) | | |
| 25 | 10000.000 | 5.21 | 1.83481 | 42.7 |
| 26 | 29.600 | (Variable) | | |
| 27* | 48.806 | 3.46 | 1.85400 | 40.4 |
| 28 | 74.579 | (Variable) | | |
| 29 | 108.338 | 3.97 | 1.84666 | 23.8 |
| 30 | ∞ | (Variable) | | |
| Image | ∞ | | | |
| Plane | | | | |

ASPHERIC DATA
1st Surface
K = 0.00000e+00 A 4 = 1.03546e−04 A 6 = 4.52552e−07
A 8 = 1.71262e−10 A10 = −2.10146e−15
A 3 = −1.71765e−04 A 5 = −9.56392e−06 A 7 = −1.21256e−08
A 9 = −8.87611e−13
2nd Surface
K = −7.29770e+00 A 4 = 2.00242e−04 A 6 = −7.67751e−08
A 8 = −2.95228e−09 A10 = −1.07234e−12
A 3 = −2.11252e−04 A 5 = −1.14810e−05 A 7 = 4.83862e−08
A 9 = 8.60298e−11
18th Surface
K= 0.00000e+00 A 4 = −2.36061e−05 A 6 = 2.78050e−08
A 8 = −1.31792e−09 A10 = 2.46018e−12
19th Surface
K = 0.00000e+00 A 4 = −9.39007e−07 A 6 = −9.34847e−08
A 8 = −1.47576e−09 A10 = −2.14815e−12
27th Surface
K = 0.00000e+00 A 4 = −1.48537e−06 A 6 = 1.05583e−08
A 8 = −8.18034e−13 A10 = 4.72885e−14 A12 = −6.97110e−17
VARIOUS DATA
Zoom Ratio 1.90

| | WIDE | MIDDLE | TELE |
|---|---|---|---|
| Focal Length | 12.13 | 17.70 | 23.06 |
| Fno | 4.10 | 4.10 | 4.10 |
| Half Angle of View (°) | 60.71 | 50.00 | 42.60 |
| Image Height | 18.80 | 20.73 | 21.64 |
| Overall Lens Length | 140.00 | 132.43 | 131.52 |
| BF | 8.00 | 8.00 | 8.00 |
| d 9 | 27.73 | 12.17 | 3.63 |
| d10 | 2.75 | 1.83 | 2.18 |
| d12 | 4.47 | 5.39 | 5.04 |
| d24 | 3.93 | 3.93 | 3.93 |
| d26 | 4.05 | 4.05 | 4.05 |
| d28 | 1.00 | 8.99 | 16.62 |
| d30 | 8.00 | 8.00 | 8.00 |

ZOOM LENS UNIT DATA

| Lens Unit | Starting Surface | Focal Length |
|---|---|---|
| 1 | 1 | −22.81 |
| 2 | 11 | 111.43 |
| 3 | 13 | 34.43 |
| 4 | 25 | −35.57 |
| 5 | 27 | 155.74 |
| 6 | 29 | 127.96 |

TABLE 1
summarizes various values in each example.

| | Ex. 1 | Ex. 2 | Ex. 3 | Ex. 4 | Ex. 5 | Ex. 6 |
|---|---|---|---|---|---|---|
| (1) | 0.50 | 0.50 | 0.50 | 0.75 | 0.42 | 0.51 |
| (2) | 64.51 | 64.53 | 70.88 | 59.03 | 63.49 | 51.81 |
| (3) | 44.27 | 48.84 | 33.79 | 70.23 | 44.27 | 49.60 |
| (4) | 0.51 | 0.54 | 0.60 | 0.49 | 0.50 | 0.48 |
| (5) | 0.093 | 0.091 | 0.091 | 0.057 | 0.090 | 0.083 |
| (6) | −0.34 | −0.35 | −0.21 | −0.23 | −0.35 | −0.36 |
| (7) | 0.22 | 0.22 | 0.23 | 0.18 | 0.24 | 0.18 |
| (8) | 1.38 | 1.33 | 0.84 | 4.68 | 1.16 | 4.22 |
| (9) | 1.61 | 1.53 | 1.65 | 1.49 | 1.61 | 1.77 |
| (10) | 29.13 | 32.32 | 25.46 | 52.32 | 29.13 | 70.23 |
| (11) | 32.32 | 37.37 | 40.73 | 37.21 | 32.32 | 32.10 |
| (12) | 5.99 | 5.21 | 6.40 | 0.15 | 6.00 | 1.04 |
| (13) | −1.00 | −1.09 | −1.09 | −0.79 | −0.96 | −0.70 |
| (14) | −12.66 | −14.20 | −21.89 | −13.07 | −12.57 | −10.19 |
| (15) | 0.44 | 0.43 | 0.42 | 0.67 | 0.42 | 0.45 |

| | Ex. 7 | Ex. 8 | Ex. 9 | Ex. 10 | Ex. 11 |
|---|---|---|---|---|---|
| (1) | 0.52 | 0.52 | 0.70 | 0.51 | 0.65 |
| (2) | 47.00 | 50.12 | 60.70 | 64.53 | 60.71 |
| (3) | 94.66 | 94.66 | 70.23 | 44.27 | 70.23 |
| (4) | 0.48 | 0.28 | 0.51 | 0.50 | 0.50 |
| (5) | 0.081 | 0.079 | 0.057 | 0.089 | 0.057 |
| (6) | −0.27 | −0.19 | −0.20 | −0.37 | −0.20 |
| (7) | 0.09 | 0.15 | 0.18 | 0.22 | 0.18 |
| (8) | 10.06 | 4.95 | 3.43 | 1.46 | 3.60 |
| (9) | 1.44 | 1.44 | 1.49 | 1.61 | 1.49 |
| (10) | 70.23 | 58.90 | 42.74 | 29.13 | 42.74 |
| (11) | 29.52 | 37.95 | 37.21 | 32.32 | 37.21 |
| (12) | 1.03 | 1.12 | 1.01 | 5.54 | 1.01 |
| (13) | −0.77 | −0.86 | −0.82 | −1.02 | −0.82 |
| (14) | −8.78 | −5.00 | −13.07 | −12.68 | −13.07 |
| (15) | 0.48 | 0.46 | 0.62 | 0.44 | 0.60 |

### Image Pickup Apparatus

A description will now be given of an example of an image pickup apparatus. FIG. 34 schematically illustrates the image pickup apparatus (digital still camera) 10 according to this example. The image pickup apparatus 10 includes a camera body 13, a zoom lens 11 that is the zoom lens L0 according to any one of Examples 1 to 11, and a light receiving element (image sensor) 12 configured to photoelectrically convert an optical image formed by the zoom lens 11. In the image pickup apparatus 10, an effective image circle diameter at the wide-angle end is smaller than that at the telephoto end.

The image pickup apparatus 10 according to this example has a zoom lens 11 that is small and has excellent optical characteristics, so it can provide high-quality images.

The light receiving element 12 can use an image sensor such as a CCD or a CMOS sensor. At this time, electrically correcting various aberrations such as distortion and chromatic aberration of the image acquired by the light receiving element 12 can improve the quality of the output image.

The zoom lens L0 according to each of example can be applied not only to the digital still camera illustrated in FIG. 34 but also to various optical apparatuses such as a film-based camera, a video camera, and a telescope.

### Image Pickup System

An image pickup system (surveillance camera system) may include the zoom lens L0 according to any one of examples and a control unit configured to control the zoom lens L0. In this case, the control unit can control the zoom lens L0 so that each lens unit moves as described above during zooming, focusing, and image stabilization. The control unit does not have to be integrated with the zoom lens L0 but may be separate from the zoom lens L0. For example, the control unit (control apparatus) may be remotely disposed from a driving unit that drives each lens unit of the zoom lens L0, and may include a transmission unit that transfers control signals (commands) for controlling the zoom lens L0. This control unit can remotely control the zoom lens L0.

Moreover, an operation unit for remotely operating the zoom lens L0, such as a controller or a button may be provided to the control unit and the zoom lens L0 may be controlled in accordance with an input to the operation unit from a user. For example, a scale-up button and a scale-down button may be provided as the operation unit. In this case, a signal may be transferred from the control unit to the driving unit of the zoom lens L0 so that the magnification of the zoom lens L0 increases in a case where the scale-up button is pressed by the user and the magnification of the zoom lens L0 decreases in a case where the scale-down button is pressed by the user.

The image pickup system may include a display unit such as a liquid crystal panel that displays information (moving state) on zoom of the zoom lens L0. The information on zoom of the zoom lens L0 is, for example, zoom magnification (zoom state) and the moving amount (moving state) of each lens unit. In this case, the user can remotely operate the zoom lens L0 through the operation unit while viewing the information on zoom of the zoom lens L0 and displayed on the display unit. The display unit and the operation unit may be integrated using a touch panel or the like.

While in the examples and embodiments described above the image stabilizing unit is a lens unit that is separate from the front group or the rear group, in alternative embodiments the image stabilizing unit is a lens unit included in the front group and is a lens unit closest to the image plane included in the front group, or alternatively the image stabilizing unit is included in the rear group and is a lens unit closest to the object included in the rear group.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each example can provide a zoom lens that is small and has excellent optical characteristics even during image stabilization.

This application claims the benefit of Japanese Patent Application No. 2023-013764, filed on Feb. 1, 2023, which is hereby incorporated by reference herein in its entirety.

What is claimed is:

1. A zoom lens comprising, in order from an object side to an image side:
a front group including a plurality of lens units;
an image stabilizing unit having negative refractive power; and
a rear group including one or more lens units,
wherein each distance between adjacent lens units changes during zooming,
wherein the front group has a focus unit and an aperture stop, and
wherein the following inequalities are satisfied:
$$0.4 < DISw / DSPw < 0.8$$
$$43.2 ° < ω w < 90. °$$
where DISw is a distance on an optical axis from the aperture stop to a lens surface closest to an object in the image stabilizing unit at a wide-angle end, DSPw is a distance on the optical axis from the aperture stop to an image plane at the wide-angle end, and ωw [°] is a half angle of view of the zoom lens at the wide-angle end.

2. The zoom lens according to claim 1, wherein the following inequality is satisfied:
$$0.1 < Φ IS / Φ R < 0.8$$
where ΦIS is a maximum effective diameter among lenses included in the image stabilizing unit, and ΦR is a maximum effective diameter among lenses included in a lens unit disposed closest to the image plane of the zoom lens.

3. The zoom lens according to claim 1, wherein the following inequality is satisfied:
$$25 < ν dF < 100$$
where νdF is a maximum value of an Abbe number based on d-line of a lens included in the focus unit.

4. The zoom lens according to claim 1, wherein the following inequality is satisfied:
$$0.2 < DLFw / TLw < 0.7$$
where DLFw is a distance on the optical axis from a lens surface closest to the object at the wide-angle end to a lens surface closest to the object of the focus unit at the wide-angle end, and TLw is a distance on the optical axis from a lens surface closest to the object in the zoom lens at the wide-angle end to the image plane.

5. The zoom lens according to claim 1, wherein the following inequality is satisfied:
$$0.04 < Skw / TLw < 0.4$$
where Skw is a back focus at the wide-angle end, and TLw is a distance on the optical axis from a lens surface closest to the object of the zoom lens to the image plane at the wide-angle end.

6. The zoom lens according to claim 1, wherein a distance on the optical axis from a lens surface closest to the image plane of a lens unit having negative refractive power included in the front group to the aperture stop becomes narrower during zooming from the wide-angle end to a telephoto end.

7. The zoom lens according to claim 1, wherein the following inequality is satisfied:
$$- 0.45 < fLN / fLF < - 0.15$$
where fLN is a focal length of a lens unit having negative refractive power included in the front group, and fLF is a focal length of the focus unit.

8. The zoom lens according to claim 1, wherein the following inequality is satisfied:
$$0. < \vert fLN / fLR \vert < 0.4$$
where fLN is a focal length of a lens unit having negative refractive power included in the front group, and fLR is a focal length of a lens unit disposed closest to the image plane in the rear group.

9. The zoom lens according to claim 1, wherein the following inequality is satisfied:
$$0.5 < \vert fLR / fLIS \vert < 11.$$
where fLR is a focal length of a lens unit disposed closest to the image plane of the rear group, and fLIS is a focal length of the image stabilizing unit.

10. The zoom lens according to claim 1, wherein the following inequality is satisfied:
$$1.4 < ndF < 1.91$$
where ndF is a maximum value of a refractive index of a lens included in the focus unit for d-line.

11. The zoom lens according to claim 1, wherein the following inequality is satisfied:
$$20 < ν dGIS < 80$$
where νdGIS is an Abbe number based on d-line of a negative lens included in the image stabilizing unit.

12. The zoom lens according to claim 1, wherein the following inequality is satisfied:
$$22 < ν dGNP < 50$$
where νdG1P is an Abbe number based on d-line of a positive lens having strongest refractive power among positive lenses included in a lens unit having negative refractive power included in the front group.

13. The zoom lens according to claim 1, wherein the following inequality is satisfied:
$$0. < ( R 1 + R 2 ) / ( R 1 - R 2 ) < 13.$$
where R1 is a radius of curvature of a lens surface closest to the object of the image stabilizing unit, and R2 is a radius of curvature of a lens surface closest to the image plane of the image stabilizing unit.

14. The zoom lens according to claim 1, wherein the following inequality is satisfied:
$$- 1.6 < Ymax\_w / fLN < - 0.4$$
where Ymax_w is a maximum image height at a wide-angle end in an in-focus state at infinity, and fLN is a focal length of a lens unit having negative refractive power included in the front group.

15. The zoom lens according to claim 1, wherein the following inequality is satisfied:
$$- 40 < Dist\_w < 0$$
where Dist_w is a distortion amount at a maximum image height in an in-focus state at infinity at the wide-angle end.

16. The zoom lens according to claim 1, further comprising a memory storing distortion correction data for correcting distortion.

17. The zoom lens according to claim 1, wherein the plurality of lens units in the front group include a lens unit having negative refractive power that includes a plurality of meniscus lenses having convex surfaces toward the object side and arranged in order from the object side.

18. The zoom lens according to claim 1, wherein the plurality of lens units in the front group include a lens unit having negative refractive power that includes, in order from the object side, four or more negative lenses and at least one positive lens.

19. The zoom lens according to claim 1, wherein the plurality of lens units in the front group include a lens unit having negative refractive power that moves during zooming.

20. The zoom lens according to claim 1, wherein at the wide-angle end, a distance on the optical axis from a lens surface closest to the image plane of the plurality of lens units included in the front group to the aperture stop is a maximum distance on the optical axis among lens units included in the zoom lens.

21. The zoom lens according to claim 1, wherein the aperture stop is disposed adjacent to and on the image side of a lens unit having negative refractive power included in the front group.

22. The zoom lens according to claim 1, wherein the rear group includes a plurality of lens units in which a distance between adjacent lens units changes during zooming.

23. The zoom lens according to claim 1, wherein a lens unit disposed closest to the image plane in the rear group is fixed relative to the image plane during zooming.

24. The zoom lens according to claim 1, wherein a lens unit disposed closest to the image plane in the rear group has positive refractive power.

25. The zoom lens according to claim 1, wherein the focus unit consists of a single lens.

26. The zoom lens according to claim 1, wherein the image stabilizing unit consists of two or less lenses.

27. The zoom lens according to claim 1, wherein the image stabilizing unit is included in the front group and is a lens unit closest to the image plane included in the front group.

28. The zoom lens according to claim 1, wherein the image stabilizing unit is included in the rear group and is a lens unit closest to the object included in the rear group.

29. A zoom lens comprising, in order from an object side to an image side:
a front group including a plurality of lens units and an aperture stop;
an image stabilizing unit having negative refractive power; and
a rear group including one or more lens units,
wherein each distance between adjacent lens units changes during zooming, and
wherein the following inequalities are satisfied:
$$0.4 < DISw / DSPw < 0.8$$
$$0. < ( R 1 + R 2 ) / ( R 1 - R 2 ) < 13.$$
$$0.1 < Φ IS / Φ R < 0.8$$
where DISw is a distance on an optical axis from the aperture stop to a lens surface closest to an object in the image stabilizing unit at a wide-angle end, DSPw is a distance on the optical axis from the aperture stop to an image plane at the wide-angle end, R1 is a radius of curvature of a lens surface closest to the object of the image stabilizing unit, R2 is a radius of curvature of a lens surface closest to the image plane of the image stabilizing unit, ΦIS is a maximum effective diameter among lenses included in the image stabilizing unit, and ΦR is a maximum effective diameter among lenses included in a lens unit disposed closest to the image plane of the zoom lens.

30. An image pickup apparatus comprising:
a zoom lens; and
an image sensor configured to receive an image formed by the zoom lens,
wherein the zoom lens includes, in order from an object side to an image side:
a front group including a plurality of lens units;
an image stabilizing unit having negative refractive power; and
a rear group including one or more lens units,
wherein each distance between adjacent lens units changes during zooming,
wherein the front group has a focus unit and an aperture stop, and
wherein the following inequalities are satisfied:
$$0.4 < DISw / DSPw < 0.8$$
$$43.2 ° < ω w < 90. °$$
where DISw is a distance on an optical axis from the aperture stop to a lens surface closest to an object in the image stabilizing unit at a wide-angle end, DSPw is a distance on the optical axis from the aperture stop to an image plane at the wide-angle end, and ωw [°] is a half angle of view of the zoom lens at the wide-angle end.

31. The image pickup apparatus according to claim 30, wherein an effective image circle diameter at the wide-angle end is smaller than that at a telephoto end.

32. The image pickup apparatus according to claim 30, further comprising an image stabilizing mechanism configured to move the image sensor,
wherein the image pickup apparatus performs image stabilization using the image stabilizing unit and the image sensor.
